(19) United States
(12) Patent Application Publication
(10) Pub. No.: US 2014/0114489 A1
(43) Pub. Date: Apr. 24, 2014

(54) SUSTAINABLE ENERGY EFFICIENCY MANAGEMENT SYSTEM

(71) Applicant: John M. Duff, Carmel, IN (US)

(72) Inventor: John M. Duff, Carmel, IN (US)

(73) Assignee: ENTHENERGY, LLC., Indianapolis, IN (US)

(21) Appl. No.: 14/124,320

(22) PCT Filed: Jun. 11, 2012
(86) PCT No.: PCT/US2012/041966

§ 371 Date: Dec. 6, 2013

Related U.S. Application Data
(60) Provisional application No. 61/495,782, filed on Jun. 10, 2011.

(51) Int. Cl. G06Q 50/06

(52) U.S. Cl. CPC G06Q 50/06
USPC 700/291

(57) ABSTRACT

Illustrative embodiments of a sustainable energy management system (SEEMS) are disclosed. Embodiments of the SEEMS may illustratively include a sustainable energy efficiency hardware platform, a local sustainable energy efficiency software platform, a hosted sustainable energy efficiency software platform, and a sustainable energy efficiency business process. The SEEMS may generate graphical energy efficiency reports, graphical budget impact reports, and graphical energy summary reports, among many other outputs.

### CROSS REFERENCE TO RELATED APPLICATION

This application claims priority to U.S. Provisional Application No. 61/495,782, filed Jun. 10, 2011, the entire disclosure of which is hereby incorporated by reference.

### BACKGROUND ART

Most energy management systems (EMS) are actually building automation systems that provide very little feedback on a building's total energy efficiency. These EMS have very limited effectiveness for sustainable energy efficiency management due to their inherent limitations, including, but not limited to, the need for highly trained personnel to operate the EMS, the need for specially trained analysts and engineers to interpret the data, the need for service technicians capable of acting on the information to maintain the efficient performance of building systems, the lack of supervisory energy efficiency performance reports to enable upper management to monitor building performance on an ongoing basis, and a fundamental disconnect with the vast majority of the people who impact most energy use within a building.

Current utility metering systems are designed to serve the needs of the utility industry, not the consumer. Even the widespread use of interval data meters on buildings and the advent of “smart meters,” primarily for residential use, provide little useful information by which a consumer can manage their energy use. Utility companies often dispose of detailed interval electric meter data, typically 15-minute average power readings, when the information is no longer useful for billing or load management (e.g., distribution system planning). Typically, utility companies hold on to no more than one year's worth of detailed data before it is deleted. By disposing of detailed building energy data that is more than a year old, there is very little information to evaluate whether present day energy use is normal or not. Furthermore, residential buildings have historically only had monthly billing data available—too long a time interval to be useful in diagnosing energy use issues. New-generation “smart meters” will allow utilities to remotely read residential meters, turn service off and on, implement power-reduction strategies involving cycling major residential loads (e.g., air conditioning, electric dryers, and dishwashers), and enable utilities to impose time-of-use utility rates (with hourly rates much higher during peak times) in order to drive consumption to off-peak hours.

Neither EMS nor utility-provided metering informs a consumer if they are wasting energy; these systems are simply not designed or implemented in a way that provides useful energy efficiency feedback to the consumer. Nearly all buildings experience a reduction in energy efficiency over time as equipment settings change, configurations are modified, operating schedules are adjusted, and equipment malfunctions. Department of Energy studies show that, on average, large buildings waste 20 to 30% of the energy they consume. Even new buildings that are fully commissioned (i.e., all systems checked for proper operation and set-points) begin to degrade shortly after the building is occupied. Long-term monitoring is needed to detect this naturally occurring degradation, as well as incorrect operation of equipment that increases energy use. Even systems that have been installed with the express purpose of saving energy lack the necessary analysis and feedback mechanisms to detect and report energy efficiency issues.

### DISCLOSURE OF INVENTION

The present invention may comprise any one or more of the features recited in the appended claims, any one or more of the following features, and/or any combinations thereof.

According to one aspect, a graphical energy efficiency report may comprise a first graphical element illustrating an adjusted energy use parameter for a building during a historic time period, a second graphical element illustrating an energy use parameter for the building during a current time period, the historical time period corresponding to the current time period, and a third graphical element illustrating a difference between the adjusted energy use parameter for the building during the historic time period and the energy use parameter for the building during the current time period.

In some embodiments, the adjusted energy use parameter for the building during the historic time period may be the result of an automated regression analysis that adjusts an actual energy use parameter for the building during the historic time period for changed conditions between the historic time period and the current time period. The automated regression analysis may be based, at least in part, upon a building type assigned to the building and to one or more similar buildings. The building type assigned to the building and to the one or more similar buildings may be based upon a sufficient number of building characteristics to result in a stable automated regression analysis.

In other embodiments, the current time period may be one month of a current year and the historic time period may be one corresponding month of a base year. The current year may comprise the most recent twelve months, and the base year may comprise the twelve months immediately preceding the most recent twelve months. The current year may comprise the most recent twelve months, and the base year may comprise twelve months other than the twelve months immediately preceding the most recent twelve months.

In still other embodiments, the first, second, and third graphical elements may be displayed for each month of the current year. The current year may comprise the most recent twelve months, and the base year may comprise the twelve months immediately preceding the most recent twelve months. The current year may comprise the most recent twelve months, and the base year may comprise twelve months other than the twelve months immediately preceding the most recent twelve months.

In some embodiments, the graphical energy efficiency report may further comprise a textual element representing a sum of the energy use parameters for the building during each month of the current year. The graphical energy efficiency report may further comprise a textual element representing a sum of the differences between the adjusted energy use parameters and the energy use parameters for the building during each month of the current year. The graphical energy efficiency report may further comprise an icon representing whether a sum of the differences between the adjusted energy use parameters and the energy use parameters for the building during each month of the current year is positive or negative.

In other embodiments, the first graphical element may comprise a first bar of a bar graph, the second graphical element may comprise a second bar of the bar graph, and the third graphical element may comprise a third bar of the bar graph. Each of the first, second, and third bars may be located above an axis of the bar graph when representing a positive value and below the axis of the bar graph when representing a negative value. The first graphical element may comprise a first color, the second graphical element may comprise a second color, and the third graphical element may comprise a third color.

In still other embodiments, the graphical energy efficiency report may further comprise a first textual element representing the adjusted energy use parameter for the building during the historic time period, a second textual element representing the energy use parameter for the building during the current time period, and a third textual element representing the difference between the adjusted energy use parameter for the building during the historic time period and the energy use parameter for the building during the current time period. The first graphical element and the first textual element may each comprise a first color, the second graphical element and the second textual element may each comprise a second color, and the third graphical element and the third textual element may each comprise a third color. A positive value for the third graphical element and the third textual element may represent an energy efficiency improvement and a negative value for the third graphical element and the third textual element may represent an energy efficiency reduction.

In some embodiments, the energy use parameter and the adjusted energy use parameter may both comprise an electricity consumption of the building. The energy use parameter and the adjusted energy use parameter may both comprise a natural gas consumption of the building. The energy use parameter and the adjusted energy use parameter may both comprise a total energy consumption of the building. The energy use parameter and the adjusted energy use parameter may both comprise an equivalent CO2 emissions value of the building.

According to another aspect, one or more computer-readable media may comprise a plurality of instructions that, when executed by a processor, result in the processor generating any of the graphical energy efficiency reports described above.

According to yet another aspect, a graphical budget impact report may comprise a first graphical element illustrating an energy efficiency budget impact for a building during a current time period as compared to a historical time period corresponding to the current time period, a second graphical element illustrating a utility rate budget impact for the building during the current time period as compared to the historical time period, and a third graphical element illustrating a sum of the energy efficiency budget impact and the utility rate budget impact for the building during the current time period as compared to the historical time period.

In some embodiments, the energy efficiency budget impact may comprise a current utility rate during the current time period multiplied by a difference between an adjusted energy use parameter for the building during the historic time period and an energy use parameter for the building during the current time period, and the utility rate budget impact may comprise the adjusted energy use parameter for the building during the historic time period multiplied by a difference between a historic utility rate during the historic time period and the current utility rate during the current time period.

In such embodiments, the adjusted energy use parameter for the building during the historic time period may be the result of an automated regression analysis that adjusts an actual energy use parameter for the building during the historic time period for changed conditions between the historic time period and the current time period. The automated regression analysis may be based, at least in part, upon a building type assigned to the building and to one or more similar buildings. The building type assigned to the building and to the one or more similar buildings may be based upon a sufficient number of building characteristics to result in a stable automated regression analysis.

In such embodiments, the energy use parameter and the adjusted energy use parameter may both comprise an electricity consumption of the building. The energy use parameter and the adjusted energy use parameter may both comprise a natural gas consumption of the building. The energy use parameter and the adjusted energy use parameter may both comprise a total energy consumption of the building.

In other embodiments, the current time period may be one month of a current year and the historic time period may be one corresponding month of a base year. The current year may comprise the most recent twelve months, and the base year may comprise the twelve months immediately preceding the most recent twelve months. The current year may comprise the most recent twelve months, and the base year may comprise twelve months other than the twelve months immediately preceding the most recent twelve months.

In still other embodiments, the first, second, and third graphical elements may be displayed for each month of the current year. The current year may comprise the most recent twelve months, and the base year may comprise the twelve months immediately preceding the most recent twelve months. The current year may comprise the most recent twelve months, and the base year may comprise twelve months other than the twelve months immediately preceding the most recent twelve months.

In some embodiments, the graphical budget impact report may further comprise a first textual element representing an overall energy efficiency budget impact for the building during the current year as compared to the base year, a second textual element representing an overall utility rate budget impact for the building during the current year as compared to the base year, and a third textual element representing a sum of the overall energy efficiency budget impact and the overall utility rate budget impact for the building during the current year as compared to the base year. The first graphical element and the first textual element may each comprise a first color, the second graphical element and the second textual element may each comprise a second color, and the third graphical element and the third textual element may each comprise a third color. A positive value for any of the first, second, and third graphical elements and the first, second, and third textual elements may represent a reduced energy cost and a negative value for any of the first, second, and third graphical elements and the first, second, and third textual elements may represent an increased energy cost.

In other embodiments, the graphical budget impact report may further comprise a first icon representing whether an overall energy efficiency budget impact for the building during the current year as compared to the base year is positive or negative, a second icon representing whether an overall utility rate budget impact for the building during the current year as compared to the base year is positive or negative, and a third icon representing whether a sum of the overall energy efficiency budget impact and the overall utility rate budget impact for the building during the current year as compared to the base year is positive or negative. The first graphical element may comprise a first bar of a bar graph, the second graphical element may comprise a second bar of the bar graph, and the third graphical element may comprise a third bar of the bar graph. The first and second bars may be superimposed over the third bar on a common axis of the bar graph. Each of the first, second, and third bars may be located above the common axis of the bar graph when representing a positive value and below the common axis of the bar graph when representing a negative value. The first graphical element may comprise a first color, the second graphical element may comprise a second color, and the third graphical element may comprise a third color.

In still other embodiments, the graphical budget impact report may further comprise a first textual element representing the energy efficiency budget impact for the building during the current time period as compared to the historical time period, a second textual element representing the utility rate budget impact for the building during the current time period as compared to the historical time period, and a third textual element representing the sum of the energy efficiency budget impact and the utility rate budget impact for the building during the current time period as compared to the historical time period. The first graphical element and the first textual element may each comprise a first color, the second graphical element and the second textual element may each comprise a second color, and the third graphical element and the third textual element may each comprise a third color. A positive value for any of the first, second, and third graphical elements and the first, second, and third textual elements may represent a reduced energy cost and a negative value for any of the first, second, and third graphical elements and the first, second, and third textual elements may represent an increased energy cost.

According to another aspect, one or more computer-readable media may comprise a plurality of instructions that, when executed by a processor, result in the processor generating any of the graphical budget impact reports described above.

According to yet another aspect, a graphical energy summary report may comprise a first graphical element illustrating a first energy use parameter for a building during a current time period, a second graphical element illustrating a second energy use parameter for the building during the current time period, and a third graphical element illustrating a sum of the first and second energy use parameters during the current time period, wherein the first, second, and third graphical elements employ a common energy unit.

In some embodiments, the common energy unit may be used internationally. The current time period may be one month of a current year comprising the most recent twelve months. The first, second, and third graphical elements may be displayed for each month of the current year. The graphical energy summary report may further comprise a first textual element representing a sum of the first energy use parameters for the building during each month of the current year, a second textual element representing a sum of the second energy use parameters for the building during each month of the current year, and a third textual element representing a sum of the first and second energy use parameters for the building during each month of the current year. The first graphical element and the first textual element may each comprise a first color, the second graphical element and the second textual element may each comprise a second color, and the third graphical element and the third textual element may each comprise a third color.

In other embodiments, the first graphical element may comprise a first bar of a bar graph, the second graphical element may comprise a second bar of the bar graph, the third graphical element may comprise a third bar of the bar graph, and the first and second bars may be superimposed over the third bar on a common axis of the bar graph. The first graphical element may comprise a first color, the second graphical element may comprise a second color, and the third graphical element may comprise a third color.

In still other embodiments, the graphical energy summary report may further comprise a first textual element representing the first energy use parameter for the building during the current time period, a second textual element representing the second energy use parameter for the building during the current time period, and a third textual element representing the sum of the first and second energy use parameters during the current time period. The first graphical element and the first textual element may each comprise a first color, the second graphical element and the second textual element may each comprise a second color, and the third graphical element and the third textual element may each comprise a third color.

In some embodiments, the first energy use parameter may comprise an electricity consumption of the building, and the second energy use parameter may comprise a natural gas consumption of the building. The first energy use parameter may comprise a first equivalent CO2 emissions value related to electricity consumption of the building, and the second energy use parameter may comprise a second equivalent CO2 emissions value related to natural gas consumption of the building.

According to another aspect, one or more computer-readable media may comprise a plurality of instructions that, when executed by a processor, result in the processor generating any of the graphical energy summary reports described above.

According to yet another aspect, a method for sustainable energy efficiency management may comprise generating one or more energy efficiency analyses relating to a building by comparing energy use data for the building during a current time period to adjusted energy use data for the building during a historical time period corresponding to the current time period and communicating the one or more energy efficiency analyses to at least one of a building executive, a building manager, a building maintenance technician, and a building occupant or visitor.

In some embodiments, communicating the one or more energy efficiency analyses may comprise communicating the one or more energy efficiency analyses to two or more of the building executive, the building manager, the building maintenance technician, and the building occupant or visitor. The one or more energy efficiency analyses may comprise at least one of the graphical energy efficiency reports, the graphical budget impact reports, and the graphical energy summary reports described above. A positive value for an element in both the graphical energy efficiency report and the graphical budget impact report may represent an improvement in the quantity represented by the element and a negative value for an element in both the graphical energy efficiency report and the graphical budget impact report may represent a detriment in the quantity represented by the element.

In other embodiments, the adjusted energy use data for the building during the historic time period may be the result of an automated regression analysis that adjusts actual energy use data for the building during the historic time period for changed conditions between the historic time period and the current time period. The automated regression analysis may be based, at least in part, upon a building type assigned to the building and to one or more similar buildings. The building type assigned to the building and to the one or more similar buildings may be based upon a sufficient number of building characteristics to result in a stable automated regression analysis.

In still other embodiments, communicating the one or more energy efficiency analyses may comprise communicating the one or more energy efficiency analyses to a building occupant or visitor using a graphic illustrating whether energy efficiency of the building is within particular ranges. The graphic may be displayed in a public area of the building.

According to another aspect, a sustainable energy efficiency management device located at a building may comprise an energy monitoring module to collect energy use data from the building, a memory device to locally store more than twelve months of energy use data from the building, and a processor to generate one or more energy efficiency analyses relating to the building, using energy use data stored in the memory device.

In some embodiments, the energy monitoring module may comprise an incorporated energy meter to directly record energy use data from the building. The energy monitoring module may comprise a serial communications interface to receive energy use data from an energy meter of the building, the serial communications interface being optically isolated from the processor. The energy monitoring module may comprise a wireless communications interface to receive energy use data from an energy meter of the building.

In other embodiments, the memory device may locally store at least twenty-four months of energy use data from the building. The energy use data stored in the memory device may comprise interval energy use measurements taken every five minutes or less. The memory device may comprise a first-in first-out (FIFO) buffer storing interval instantaneous power measurements taken every ten seconds or less over a plurality of recent hours, and the processor may be configured to write the interval instantaneous power measurements stored in the FIFO buffer to a permanent storage location in the memory device in response to detecting an event impacting energy efficiency of the building. The processor may be configured to write interval instantaneous power measurements from both before and after the event to the permanent storage location in the memory device. The event may comprise an anomalous energy use by or within the building. The event may comprise a transitional period in a schedule of the building. The event may comprise an occurrence of a predetermined set of criteria. The FIFO buffer may also store at least one of interval voltage measurements, interval current measurements, interval power factor measurements, interval apparent power measurements, and interval reactive power measurements taken every ten seconds or less over a plurality of recent hours, and the processor may further be configured to write the at least one of interval voltage measurements, interval current measurements, interval power factor measurements, interval apparent power measurements, and interval reactive power measurements stored in the FIFO buffer to the permanent storage location in the memory device in response to detecting the event impacting energy efficiency of the building.

In still other embodiments, the sustainable energy efficiency management device may further comprise a power supply for the processor and the memory device that draws power from an electrical system of the building being monitored by the energy monitoring module. The processor may be configured not to generate control signals for any automation system of the building.

In some embodiments, the processor may be configured to generate one or more energy efficiency analyses by comparing energy use data from a current time period to adjusted energy use data from a historical time period corresponding to the current time period. The adjusted energy use data from the historic time period may be the result of an automated regression analysis that adjusts actual energy use data from the historic time period for changed conditions between the historic time period and the current time period. The automated regression analysis may be based, at least in part, upon a building type assigned to the building and to one or more similar buildings. The building type assigned to the building and to the one or more similar buildings may be based upon a sufficient number of building characteristics to result in a stable automated regression analysis. The processor may be configured to transmit a user alert in response to detecting an anomalous energy use when comparing energy use data from the current time period to adjusted energy use data from the historical time period corresponding to the current time period. The one or more energy efficiency analyses may comprise at least one of the graphical energy efficiency reports, the graphical budget impact reports, and the graphical energy summary reports described above.

According to yet another aspect, a sustainable energy efficiency management system may comprise any of the sustainable energy efficiency management devices described above, located at a building, and a server remote from the building, wherein the server is configured to communicate with the device located at the building to provide comparative energy use data collected from one or more similar buildings.

In some embodiments, the processor of the device may be configured to generate the one or more energy efficiency analyses using the comparative energy use data collected from one or more similar buildings. The processor of the device may be configured to transmit a user alert in response to an anomalous energy use detected using the comparative energy use data collected from one or more similar buildings. The device located at the building may be configured to periodically transmit energy use data to the server, without awaiting a query from the server. The device located at the building may be configured to collect energy use data from the building regardless of whether it can communicate with the server. The server may be configured to generate one or more energy efficiency analyses relating to the building, using the energy use data transmitted from the device located at the building. The one or more energy efficiency analyses may comprise at least one of the graphical energy efficiency reports, the graphical budget impact reports, and the graphical energy summary reports described above.

### BRIEF DESCRIPTION OF DRAWINGS

The concepts described in the present disclosure are illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates a simplified block diagram of at least one embodiment of a sustainable energy management system (SEEMS), including possible information flow paths between components of the SEEMS.

FIG. 2 illustrates a simplified block diagram of at least one embodiment of a sustainable energy efficiency hardware platform of the SEEMS of FIG. 1.

FIG. 3 illustrates at least one embodiment of an energy efficiency trend report showing monthly energy efficiency changes in a building's electricity use during a 24 month period.

FIG. 4 illustrates at least one embodiment of an energy efficiency trend report showing monthly energy efficiency changes in a building's natural gas use during a 24 month period.

FIG. 5 illustrates at least one embodiment of an energy efficiency trend report showing monthly energy efficiency changes in a building's total energy use during a 24 month period, expressed in MMBtu.

FIG. 6 illustrates at least one embodiment of an energy efficiency trend report showing monthly changes in the CO2 emissions released as a result of a building's energy use during a 24 month period.

FIG. 7 illustrates at least one embodiment of an energy efficiency progress report showing energy efficiency changes in a building's electricity use during a 12 month period, as compared to a fixed base year.

FIG. 8 illustrates at least one embodiment of an energy efficiency progress report showing energy efficiency changes in a building's natural gas use during a 12 month period, as compared to a fixed base year.

FIG. 9 illustrates at least one embodiment of an energy efficiency progress report showing energy efficiency changes in a building's total energy use during a 12 month period, as compared to a fixed base year, expressed in MMBtu.

FIG. 10 illustrates at least one embodiment of an energy efficiency progress report showing monthly changes in the CO2 emissions released as a result of a building's energy use during a 12 month period, as compared to a fixed base year.

FIG. 11 illustrates at least one embodiment of a budget impact trend report showing the effects of both energy efficiency changes in a building's electricity use and utility rate changes during a 24 month period.

FIG. 12 illustrates at least one embodiment of a budget impact trend report showing the effects of both energy efficiency changes in a building's natural gas use and utility rate changes during a 24 month period.

FIG. 13 illustrates at least one embodiment of a budget impact trend report showing the effects of both energy efficiency changes in a building's total energy use and utility rate changes during a 24 month period, expressed in MMBtu.

FIG. 14 illustrates at least one embodiment of a budget impact progress report showing the effects of both energy efficiency changes in a building's electricity use and utility rate changes during a 12 month period, as compared to a fixed base year.

FIG. 15 illustrates at least one embodiment of a budget impact progress report showing the effects of both energy efficiency changes in a building's natural gas use and utility rate changes during a 12 month period, as compared to a fixed base year.

FIG. 16 illustrates at least one embodiment of a budget impact progress report showing the effects of both energy efficiency changes in a building's total energy use and utility rate changes during a 12 month period, as compared to a fixed base year.

FIG. 17 illustrates at least one embodiment of a total energy summary report showing a building's total energy use (as a combination of electricity use and natural gas use) during a 12 month period.

FIG. 18 illustrates at least one embodiment of a CO2 emissions report showing the CO2 emissions released as a result of a building's energy use (as a combination of CO2 emissions released as a result of a building's electricity use and CO2 emissions released as a result of a building's natural gas use) during a 12 month period.

FIG. 19 illustrates at least one embodiment of a single screen application of the SEEMS of FIG. 1.

FIG. 20 illustrates at least one embodiment of an easy-to-understand “optimal, normal, excessive” graphic showing whether the energy efficiency of a building is within particular ranges.

### BEST MODE(S) FOR CARRYING OUT THE INVENTION

While the concepts of the present disclosure are susceptible to various modifications and alternative forms, specific embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

In the following description, numerous specific details such as logic implementations, resource partitioning/sharing/duplication implementations, types and interrelationships of system components, and logic partitioning/integration choices are set forth in order to provide a more thorough understanding of the present disclosure. It will be appreciated by one skilled in the art, however, that embodiments of the disclosure may be practiced without such specific details. In other instances, control structures, gate level circuits, and full software instruction sequences have not been shown in detail in order not to obscure the description of the of the concepts described herein. Those of ordinary skill in the art, with the included descriptions, will be able to implement appropriate functionality without undue experimentation.

References in the specification to “one embodiment,” “an embodiment,” “an example embodiment,” etcetera, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the concepts described herein may be implemented in hardware, firmware, software, or any combination thereof. Embodiments implemented in a computing device or system may include one or more point-to-point or bus-based interconnects between components. Embodiments of the concepts described herein may also be implemented as instructions carried by or stored on one or more machine-readable or computer-readable storage media, which may be read and executed by one or more processors. A machine-readable or computer-readable storage medium may be embodied as any device, mechanism, or physical structure for storing or transmitting information in a form readable by a machine (e.g., a computing device). For example, a machine-readable or computer-readable storage medium may be embodied as read only memory (ROM) device(s); random access memory (RAM) device(s); magnetic disk storage media; optical storage media; flash memory devices; mini- or micro-SD cards, memory sticks, and others.

In the drawings, specific arrangements or orderings of schematic elements, such as those representing devices, modules, software, and data elements, may be shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

In general, schematic elements used to represent software may be implemented using any suitable form of machine-readable instruction, such as software or firmware applications, programs, functions, modules, routines, processes, procedures, plug-ins, applets, widgets, code fragments and/or others, and that each such instruction may be implemented using any suitable programming language, library, application programming interface (API), and/or other software development tools. For example, some embodiments may be implemented using Java, C++, and/or other programming languages. Similarly, schematic elements used to represent data or information may be implemented using any suitable electronic arrangement or structure, such as a register, data store, table, record, array, index, hash, map, tree, list, graph, file (of any file type), folder, directory, database, and/or others.

Further, in the drawings, where connecting elements, such as solid or dashed lines or arrows, are used to illustrate a connection, relationship or association between or among two or more other schematic elements, the absence of any such connecting elements is not meant to imply that no connection, relationship or association can exist. In other words, some connections, relationships or associations between elements may not be shown in the drawings so as not to obscure the disclosure. In addition, for ease of illustration, a single connecting element may be used to represent multiple connections, relationships or associations between elements. For example, where a connecting element represents a communication of signals, data, instructions, or other information, it should be understood by those skilled in the art that such element may represent one or multiple signal paths (e.g., a bus), as may be needed, to effect the communication.

The presently disclosed sustainable energy efficiency management system (SEEMS) is wholly designed to maximize energy savings in a building using current building systems, staff, and support teams. As used in the present disclosure, the term “building” refers not only to a single building, but also to groups or campuses of buildings, as well as to sub-parts or portions of a building. By providing timely feedback, the SEEMS instills accountability for how energy is used in a building by operators and occupants and reveals the energy effects of operations and maintenance practices and activities. Lacking a method to provide such timely information and feedback, energy waste in buildings remains hidden from building owners and managers. The SEEMS seeks to minimize this waste through information technology (IT). The goal of the SEEMS is not to provide direct control over building systems but, rather, to provide useful, timely feedback regarding when energy efficiency improvement is needed. This feedback enables users to adjust and restore building systems so as to reduce energy waste and to reinforce positive energy efficiency program results. The SEEMS provides actionable energy efficiency information that allows users to adopt building-specific, performance-validated best practices and bridges the building performance communications gap that exists between building operators, managers, and maintenance personnel, on the one hand, and building owners, executives, occupants and visitors, on the other hand, by utilizing a standardized methodology applicable to every building within an organization. Furthermore, by providing energy efficiency comparisons and rankings of similar buildings, the SEEMS may promote energy use accountability and awareness by all who interact with a building.

The SEEMS methodology is fundamentally different from that of the energy performance contracting industry, which is project based and employs annual performance Measurement and Verification (M&V) methods that are designed to ignore energy-impactful building changes that are not part of the energy performance contract project. This is done to calculate savings from the project alone over contract periods of ten years or longer. In contrast, the building performance metrics of the SEEMS may be computed monthly using mathematics focused on sustainable energy efficiency management. As used in the present disclosure, the terms “monthly” and “month(s)” generally refer to the utility billing periods of a building (i.e., the time periods over which a building's energy use is billed), which may correspond to calendar months, but may also be longer or shorter time periods. The SEEMS provides formulas and graphics that deliver actionable information and a true evaluation of the energy efficiency track record of a building that can be quickly and easily interpreted by persons with limited knowledge of energy management. The SEEMS methodology provides a user with information regarding material changes in building performance in a timely manner, allowing for dramatically improved and sustainable building energy efficiency, support team productivity, occupant awareness, and effective implementation of financial controls over energy costs.

Among other characteristics, the SEEMS' capacities to garner top-level organizational support, to operate cost effectively, and to function independently of other building systems promote the sustainability of improvements to the energy efficiency of a building. First, the SEEMS is able to garner top-level organizational support by becoming an integral part of an organization's management and budget process, similar to other important business reports and metrics (e.g., accounting). The SEEMS supports organization-wide energy efficiency efforts (whether based on technology, operations and maintenance, or energy awareness), but does not require large capital expenditures to achieve and maintain significant energy savings. Second, the SEEMS costs a small fraction of the value it brings to an organization in the form of energy cost reductions, energy use reductions as part of the organization's sustainability goals, support of other green initiatives, and/or empirical evidence of the effectiveness of sustainability efforts. To operate cost effectively, the SEEMS may use automated regression analysis techniques in which regression parameters are tuned by applying constraints and other algorithmic variations based on analyses of different building types to enable consistent, stable regressions that maximize comparative value. Third, the SEEMS is able to function independently of other building systems by storing a large amount of energy use data on-site, as part of a building's long-term documentation. This valuable, long-term energy use data is not lost when hosted or other third-party services are discontinued or when a loss of connectivity to the building occurs. The SEEMS may also provide a hosted service for detailed analysis and energy comparisons, as well as off-site data archiving, even if the building itself is temporarily unavailable (as routinely happens when a building's IT infrastructure and Internet Protocol (IP) addresses are changed). Reliance upon tight integration with highly proprietary building systems is not sustainable as these systems routinely change. Attempts at integration are often considered intrusive by the building system installers, operators, and maintenance personnel and, thus, are subject to disabling or disconnection.

As will be further described below, the presently disclosed SEEMS may provide building owners, operators, technicians, and occupants with heretofore unavailable answers to the following questions, among others: Is the building using too much energy compared to its own past, to other similar buildings, and/or to an optimal benchmark for this type of building? Is the building's efficiency improving, staying the same, or getting worse? Are utility bill cost changes due to energy efficiency changes, weather differences, production changes, fluctuations in occupancy, and/or utility rate changes? Which energy saving methods work well for a particular type of building: energy efficiency technologies, energy efficient operating methods, energy efficient maintenance practices, and/or energy efficiency awareness programs?

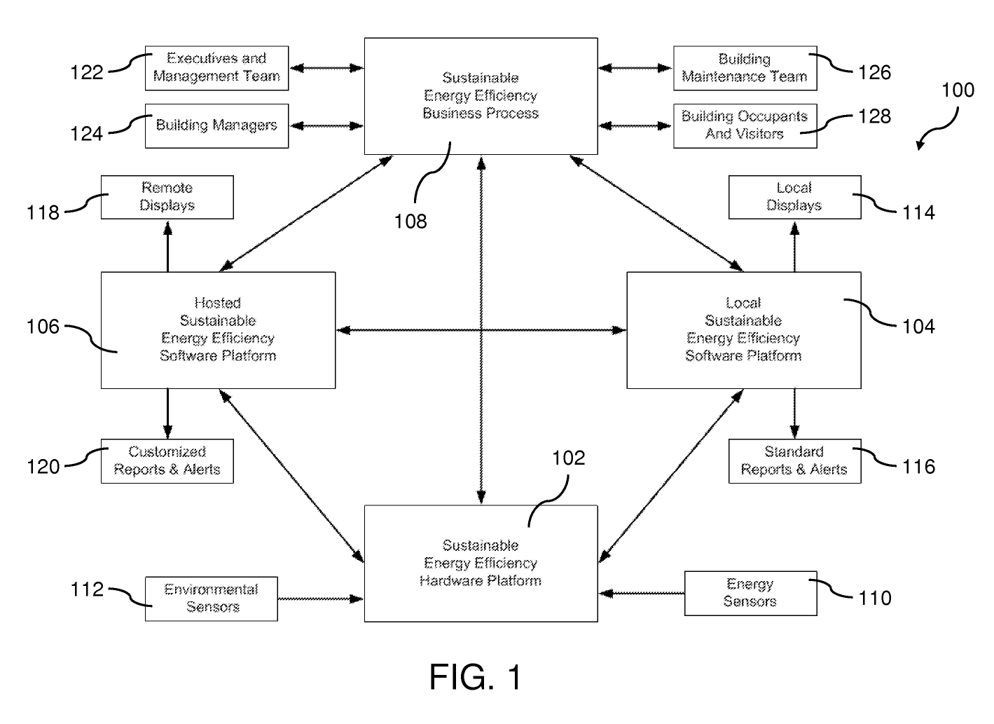

Referring now to FIG. 1, an illustrative embodiment of the SEEMS 100 is shown as a simplified block diagram. The SEEMS 100 illustratively includes four primary components: a sustainable energy efficiency hardware platform 102, a local sustainable energy efficiency software platform 104, a hosted sustainable energy efficiency software platform 106, and a sustainable energy efficiency business process 108, each of which may be interconnected with and/or interact with one another, as well as with other components of the SEEMS 100. The sustainable energy efficiency hardware platform 102 may collect, store, and process energy use data and may provide recipient-specific, actionable energy information to the appropriate person(s) at the appropriate time(s) in the appropriate format(s). The local sustainable energy efficiency software platform 104 is building-level software that may perform data collection, long-term data storage, analysis, building energy efficiency reporting, textual and graphic display, and adaptive alerting of energy issues. The local sustainable energy efficiency software platform 104 may be executed on the sustainable energy efficiency hardware platform 102 located at the building it serves. The hosted sustainable energy efficiency software platform 106 is system-wide software that may be located remotely from a building on one or more hosted servers and may provide comparative information that spans an entire population of buildings and allows higher levels of analysis, reporting, weather-corrected alerting, display, and communications capabilities. The sustainable energy efficiency business process 108 may be customized by organization to enable the direction of appropriate building performance information to the appropriate person(s) at the appropriate time(s) in the appropriate format(s) to promote the improvement and maintenance of energy efficiency efforts. The sustainable energy efficiency business process 108 may involve everyone who impacts the energy use of a building: tenants, maintenance workers, building operations staff, management, owners, and others. Each of these groups has a role in establishing and maintaining energy efficiency in a building with which they interact. The greater number of people involved in the sustainable energy efficiency business process 108, the better and more sustainable the results. Each of the foregoing components of the SEEMS 100 will be described in further detail below.

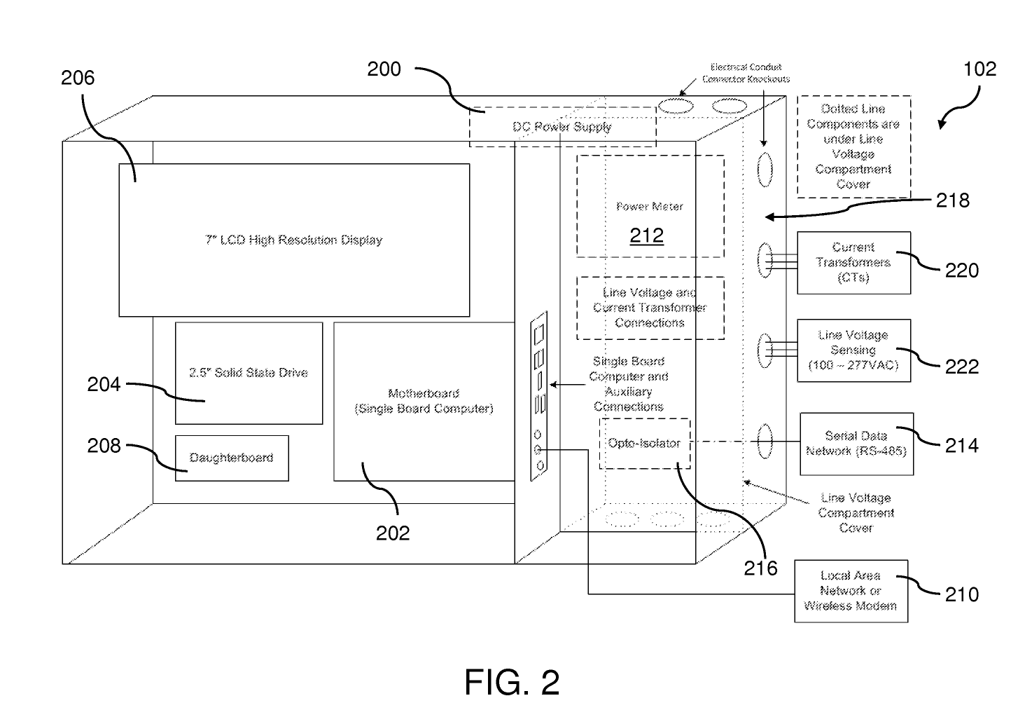

The sustainable energy efficiency hardware platform, or sustainable energy efficiency management device, 102 is physically located at or near a building to be monitored by the SEEMS 100. As shown in FIG. 1, the sustainable energy efficiency hardware platform 102 may collect energy use data from a building via any number of energy sensors 110 and may also receive inputs from any number of environmental sensors 112 (e.g., local temperature). One illustrative embodiment of the sustainable energy efficiency hardware platform 102 is shown in FIG. 2 as a simplified block diagram (hereinafter, “hardware platform 102”). In the illustrative embodiment, a DC power supply 200 supplies power to other components of the hardware platform 102 (e.g., a memory device 204) in a reliable fashion to prevent data loss. In some embodiments, the power supply 200 may receive AC power directly from the electrical power of the building being monitored using voltage sensing lines 222 which, along with current transformers 220, provide the signals necessary for a power meter 212 of the hardware platform 102 to measure power, voltage, current, and power factor. As service to buildings can range from 100 to 277 V, phase to neutral, the DC power supply 200 may be designed to accept 90 to 305 VAC, 50/60 Hz, to provide a plus or minus 10% supply voltage tolerance. In some embodiments, the DC power supply 200 may supply power to different components of the hardware platform 102 at several different voltages, avoiding the increased costs of multiple power supplies for different service voltage levels. In the illustrative embodiment, the DC power supply 200 may be embodied as a Mean Well LPF-40-12 Class 2 12 VDC power supply, with a 100 to 277 VAC plus or minus 10% input range, commercially available from Mean Well Enterprises Co., Ltd., of Taiwan.

The hardware platform 102 comprises a single board computer 202 that includes a processor to provide on-site analysis of energy use data collected from the building. The processor of the single board computer 202 may be any type of processor capable of executing software/firmware, such as a microprocessor, digital signal processor, microcontroller, or the like. In the illustrative embodiment, the processor of the single board computer 202 is embodied as a Freescale IMX53 Processor with a 32-bit Cortex-A8 ARM (Advanced RISC Machine) core operating at 1 GHz, commercially available from Freescale, Inc., of Austin, Tex. The single board computer 202 may also include RAM of sufficient size and speed to enable database and graphics programs to run simultaneously. In the illustrative embodiment, the single board computer 202 includes 1 GB of DDR2 memory operating at 800 MHz. The single board computer 202 may also output graphics to a display 206 mounted on or within the hardware platform 102 and/or may output graphics to displays external to the hardware platform 102. In the illustrative embodiment, the single board computer 202 is embodied as a Boundary Devices Nitrogen53, available from Boundary Devices of Chandler, Ariz., which provides multiple display options, including low-voltage differential signaling (LVDS) and a high-definition multimedia interface (HDMI) with 1080P video playback capability.

The hardware platform 102 also comprises a memory device 204 capable of storing more than twelve months of energy use data collected from the building. In the illustrative embodiment, the memory device 204 may be embodied as a 60 GB solid state drive. The energy use data stored on the memory device 204 may include interval energy use measurements (e.g., kWh) taken every five minutes or less. In some embodiments, the memory device 204 may also store detailed records of events impacting the energy efficiency of the building for future analysis and/or comparison. For instance, the memory device 204 may store ten second or less interval data for short-lived energy issues, such as equipment cycling. In one illustrative embodiment, the hardware platform 102 may record interval instantaneous power measurements taken every ten seconds or less (over several hours) in a first-in first-out (FIFO) buffer, which may reside in either the RAM of the single board computer 202 or the memory device 204. In addition to these interval instantaneous power measurements, the FIFO buffer may also store interval voltage measurements, interval current measurements, interval power factor measurements, interval apparent power measurements, interval reactive power measurements, and the like. When the processor of the single board computer 202 detects an event impacting energy efficiency of the building, the processor may write the interval instantaneous power measurements stored in the FIFO buffer to a permanent storage location in the memory device 204. In one embodiment, six-second interval data from three hours before an event until one hour after the event may be stored in the memory device 204, so that a thorough analysis can be performed on the energy use leading up to the event and the energy use immediately after the event. It is contemplated that the event triggering the retention of detailed data from the FIFO buffer may be an anomalous energy use by the building, a transitional period in a schedule of the building (e.g., a Monday morning system start-up), the occurrence of some predetermined set of criteria, or any other event impacting energy efficiency of the building.

The hardware platform 102 may use multiple communications modes to gather and report information, such as RS-485, RS-232, USB, and Ethernet, as well as various wired and wireless communications protocols commonly used in building information systems. These protocols may include, for example, TCP/IP, Modbus, BACnet, LonWorks, DeviceNet, SOAP, XML, ZigBee, Synapse, and other wireless mesh network devices, WiFi, and cellular data communications. In the illustrative embodiment shown in FIG. 2, the single board computer 202, in combination with a daughterboard 208 and/or an external modem 210, incorporates all of these communications modes. The hardware platform 102 may also have interfaces that will allow the addition of modems and other interface devices needed to communicate with future building energy and information devices, without unduly adding cost to the standard hardware platform by complicating design and certification requirements. In some embodiments, the hardware platform 102 may also include a touch screen for installation and set-up tutorials, diagnostic processes, and updating information sets for digital signage and display.

The hardware platform 102 may include an energy (kilowatt-hour) meter 212 that directly monitors service entrance or sub-metered loads and/or that can be equipped with the appropriate protocol and communications mode to interface with a local energy metering system or other information systems needed to provide a source of energy use data. The serial communications bus that may connect to other local metering devices is isolated between the serial data network 214 and one of the serial ports on the single board computer 202 by an opto-isolator 216. The opto-isolator 216 ensures that any dangerous voltages that may be introduced to the serial data network 214 (for instance, by way of their penetration into electrical service panels) is limited to the line voltage section 218 of the hardware platform 102, which is covered and otherwise electrically isolated from the rest of the hardware platform 102 during normal operations.

As described in more detail below, the hardware platform 102 may communicate with a hosted server executing the hosted sustainable energy efficiency software platform 106 (e.g., via the LAN or wireless modem 210). In the illustrative embodiment, the hardware platform 102 reports digitally encrypted information out to the hosted server on a periodic basis. This reporting method is more reliable to maintain connectivity than the standard “query-response” relationship, where a local device collects data and awaits periodic download commands from a remote device reliant upon a dedicated IP address. The hardware platform 102 is able to respond to routine optimization reports and alert settings from the hosted server and also allows for remote software system maintenance and upgrades from the hosted server. Although the hardware platform 102 may interact with a hosted server as just described, the hardware platform 102 also provides significant analysis and reporting capability independent of the hosted server (i.e., regardless of its connection to the hosted server), based on the latest optimization settings received from the hosted sustainable energy efficiency software platform 106.

Furthermore, the hardware platform 102 may be rugged, fanless, low-cost, unobtrusive, non-threatening to existing building infrastructure, and field-maintainable with removable components to allow for repairs without the need to uninstall the hardware platform 102. Local access to the hardware platform 102 is available using the LAN and a standard web browser. Direct connections can also be made to the hardware platform 102 using wired or wireless communications, depending on the installation.

Referring again to FIG. 1, the local sustainable energy efficiency software platform 104 takes in information either from energy sensors 110 supplied with the hardware platform 102 or from existing open-protocol energy sensors that either report their energy use to the local software platform 104 at regular intervals or are periodically queried by the local software platform 104. By way of example, the local software platform 104 may monitor both real and virtual meters, an entire building's service entrance, metered sub-sections of a building, equipment, systems, and/or calculated sub-loads. In some embodiments, the local software platform 104 may also have one year of utility interval data configured, analyzed, and loaded during setup to provide an energy usage history immediately upon installation of the hardware platform 102. The local software platform 104 analyzes energy use data to provide valuable information that is accurate, weather-corrected, adjusted for known occupancy or production variations, and timely enough to provide suitable feedback and motivation towards actual energy efficiency improvements. The local software platform 104 may output its energy efficiency analyses via local displays 114 and/or via standard reports and alerts 116.

In the illustrative embodiment, the local software platform 104 is able to survive the temporary loss of its Internet connection. The local software platform 104 continues to collect and process energy use data and automatically generate alerts 116, as needed. This energy use data may be queued up to send when Internet access is restored. Updates and other information that would have been received during the outage are also available to be retrieved. The local software platform 104 is able to process and store multiple years of energy efficiency reports, even those that are generated by the hosted sustainable energy efficiency software platform 106, for future retrieval, even if hosted services have been terminated. Past energy issues for the building, as well as methods used to improve energy efficiency, may also be stored for future retrieval so that an ongoing record is readily available to assist future energy efficiency efforts.

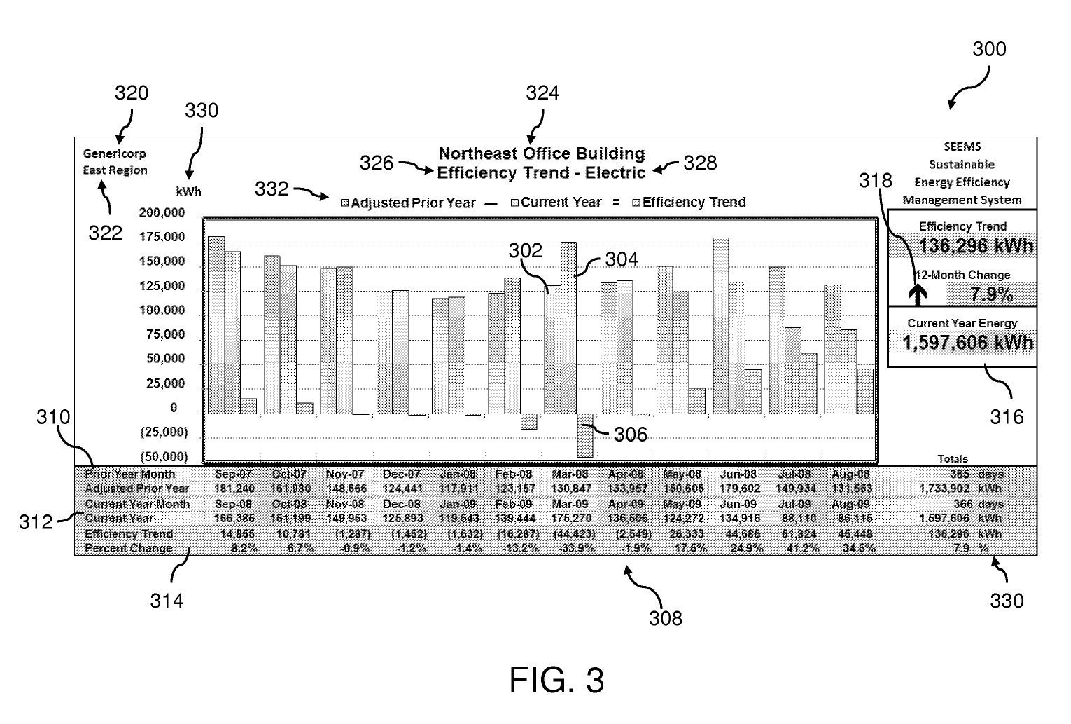

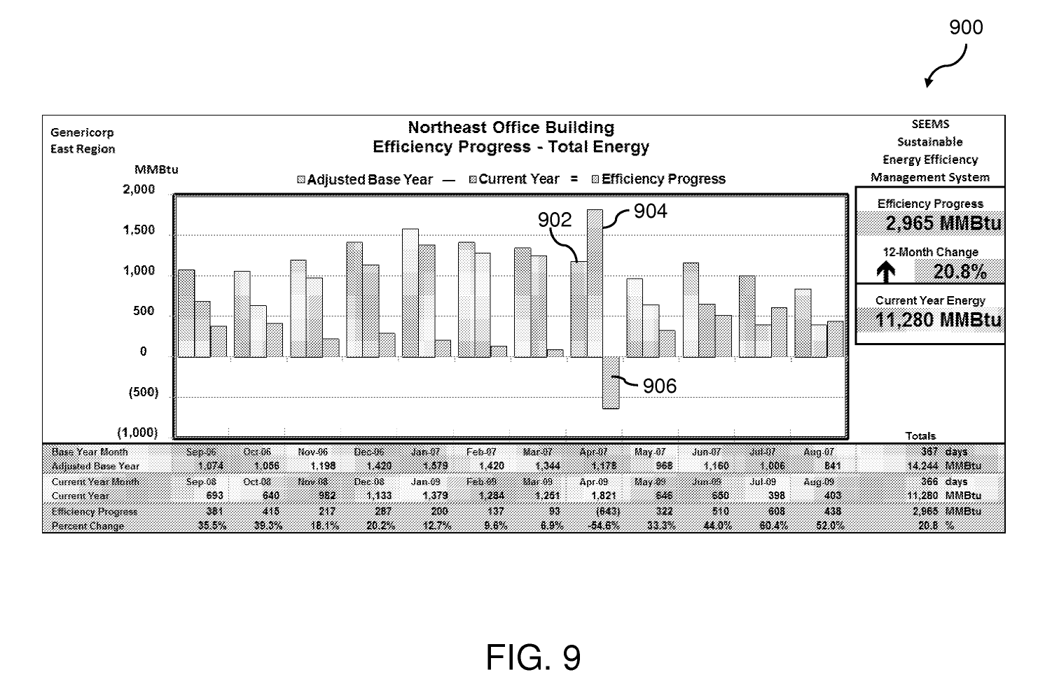

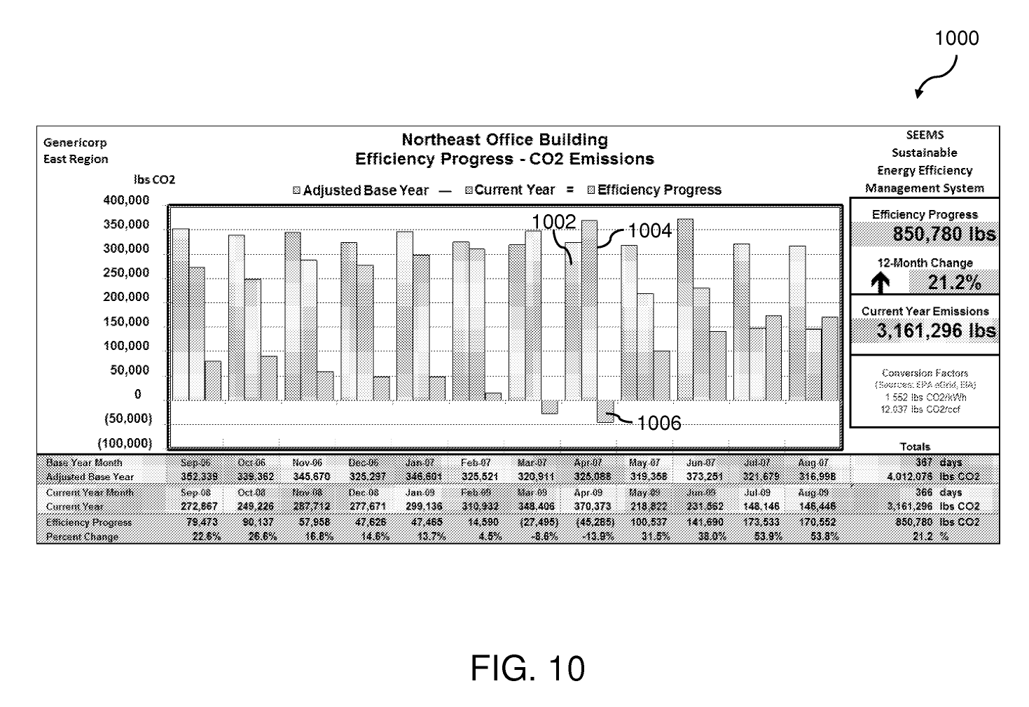

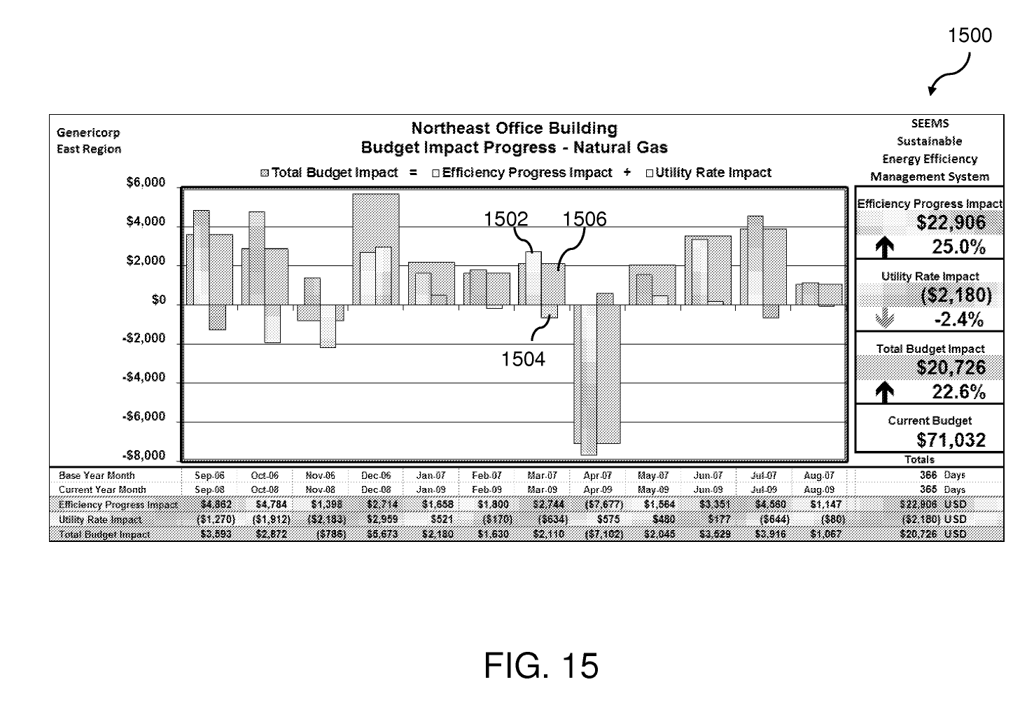

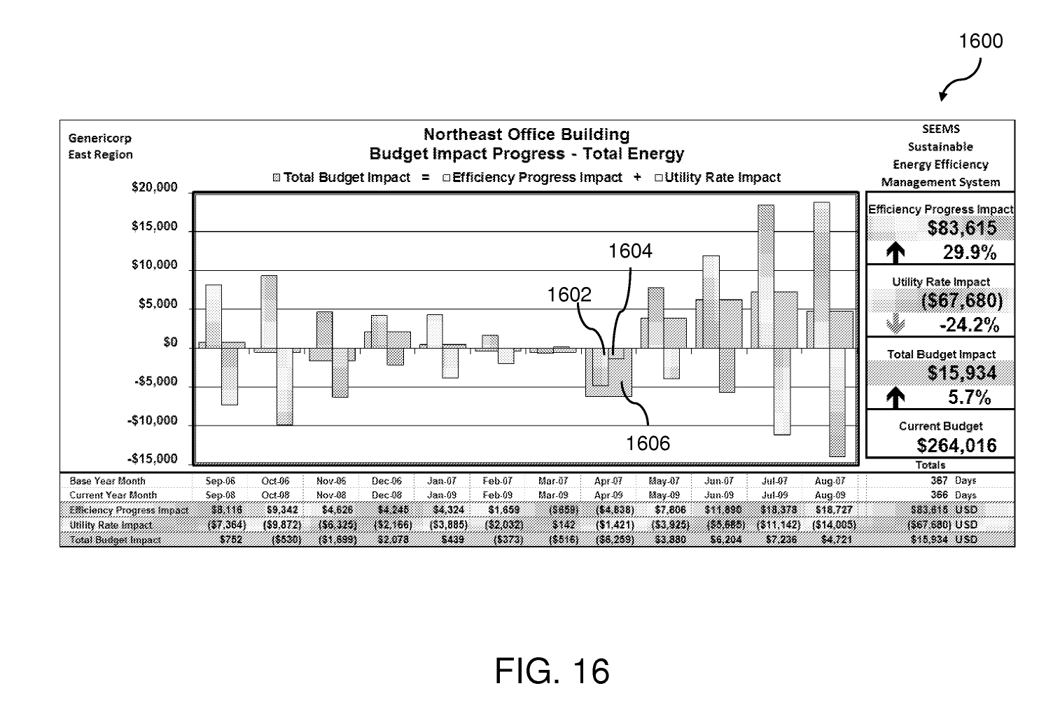

The hosted sustainable energy efficiency software platform 106 of the SEEMS 100 uses automated regression analysis to accomplish weather, occupancy, and/or production variations so that the resulting platform provides accurate, meaningful energy efficiency information at low cost. The automated regression analysis finds the most suitable relationship between the dependent variable, energy, and the independent variables (energy use time length, outside air temperature, occupancy or production, by way of example) and calculates an adjusted historic energy use based on current values of the independent variables. The energy efficiency change is the difference between the adjusted historic energy use and the current energy use. The hosted software platform 106 may output its energy efficiency analyses via remote displays 118 and/or via custom reports and alerts 120. Several illustrative examples of custom reports and alerts 120 that may be generated by the hosted software platform 106 are shown in FIG. 3-20.

An energy efficiency trend report 300 is illustrated in FIG. 3. As used in the present disclosure, a “trend” report compares a 12-month period to the 12-month period that immediately preceded it. As shown in FIG. 3, the energy efficiency trend report 300 includes an easy-to-interpret graphic where the comparison years are shown side by side as the first bar 302 and the second bar 304 of a bar graph. The value represented by the third bar 306 of the bar graph is calculated by subtracting the second bar 304 from the first bar 302. This procedure yields positive energy efficiency changes that are indicated by bars 306 above an axis of the bar graph, negative changes by bars 306 below the axis of the bar graph. This convention is consistent throughout the graphical reports of the SEEMS 100, enabling easy comprehension and dependable interpretation. As shown in FIG. 3, the bars 302-06 are displayed for each of the twelve months of the current year. It will be appreciated that, although the energy efficiency trend report 300 is illustrated as including a bar graph in FIG. 3, other embodiments may use different types of graphical elements in the place of the bars 302-306.

In the illustrative embodiment, the energy efficiency trend report 300 also includes a table 308 provided directly below the bars 302-06 associated with each month. The color of the first, second, and third rows 310, 312, 314 matches the color of the first, second, and third bars 302, 304, 306, respectively, to aid in finding the correct data. A month-by-month change in the efficiency trend is shown in the third row 314 for easy reference. A summary area 316 on the right side of the energy efficiency trend report 300 presents summary results for the current year in a dashboard fashion. While building and energy efficiency program managers may find the detailed information of the table 308 more important, financial and business executives will likely focus on the bottom line numbers in the summary area 316. The background colors of the summary area 316 numbers match the colors of the bars 302-306 and the rows 310-314 that the numbers are summarizing. Furthermore, an icon 318 (e.g., such as a green up arrow for positive results, or a red down arrow for negative results) enables the quick evaluation of many reports.

For easy reference, the energy efficiency trend report 300 has key identifying information. For instance, the customer name 320 is displayed in the upper left-hand corner. The report grouping 322 is located just below the customer name 320. The customer may select any of four custom report groupings to enable summary reports to be aggregated in a manner that is most informative. For instance, a customer may group different buildings by geographic region, business type, building use, occupancy type, or the like. These custom groupings are configured during the initial customer set up. The building name 324 is displayed prominently at the top of the energy efficiency trend report 300. The report type 326 begins the line below the building name 324. The meter name or energy type 328 ends the line below the building name 324. The units 330 associated with the energy efficiency trend report 300 are at the top of the primary y-axis as well as in the last column of the table 308. At the top of the energy efficiency trend report 300 (as well as the other reports disclosed herein), the color-coded legend 332 also shows the equation used to obtain the values displayed in the report.

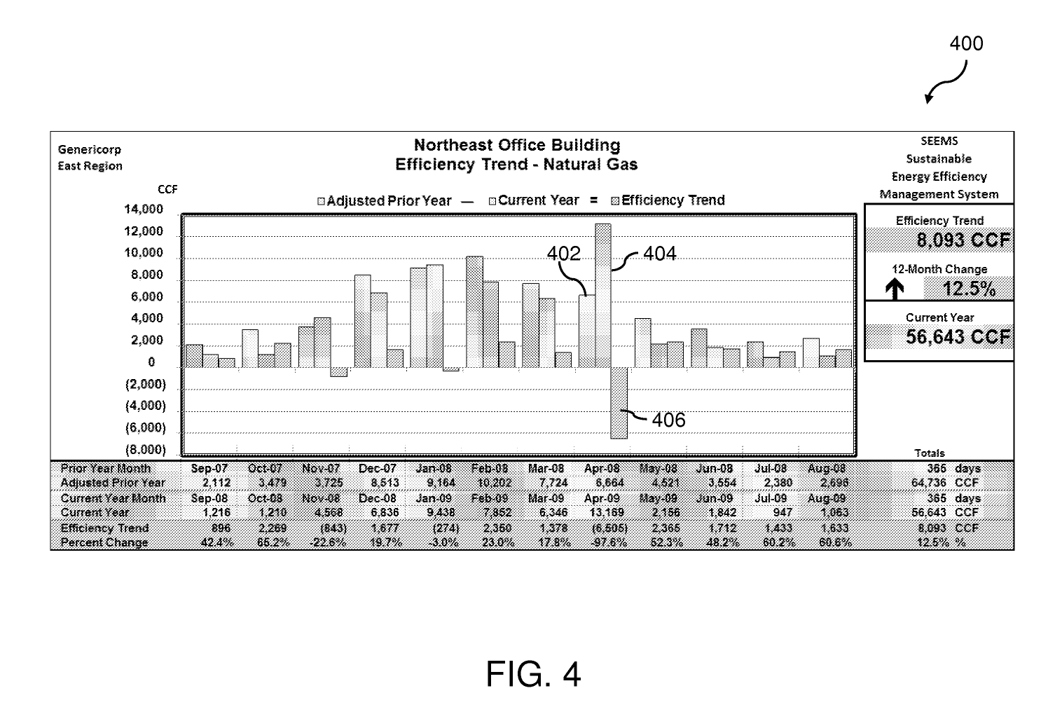

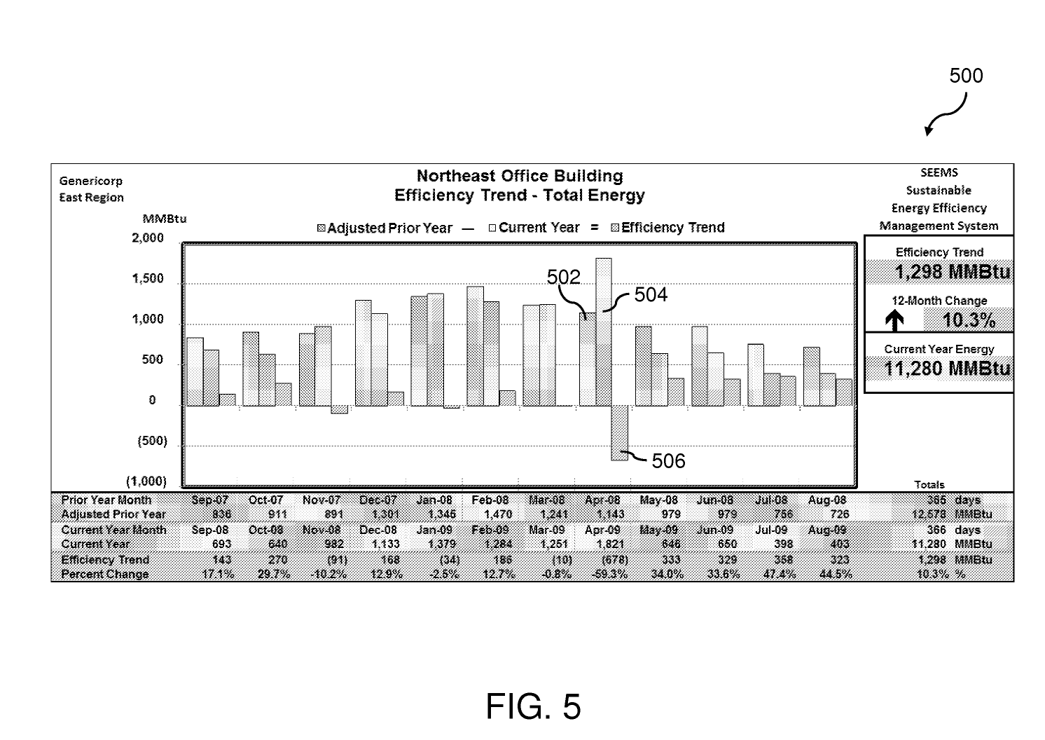

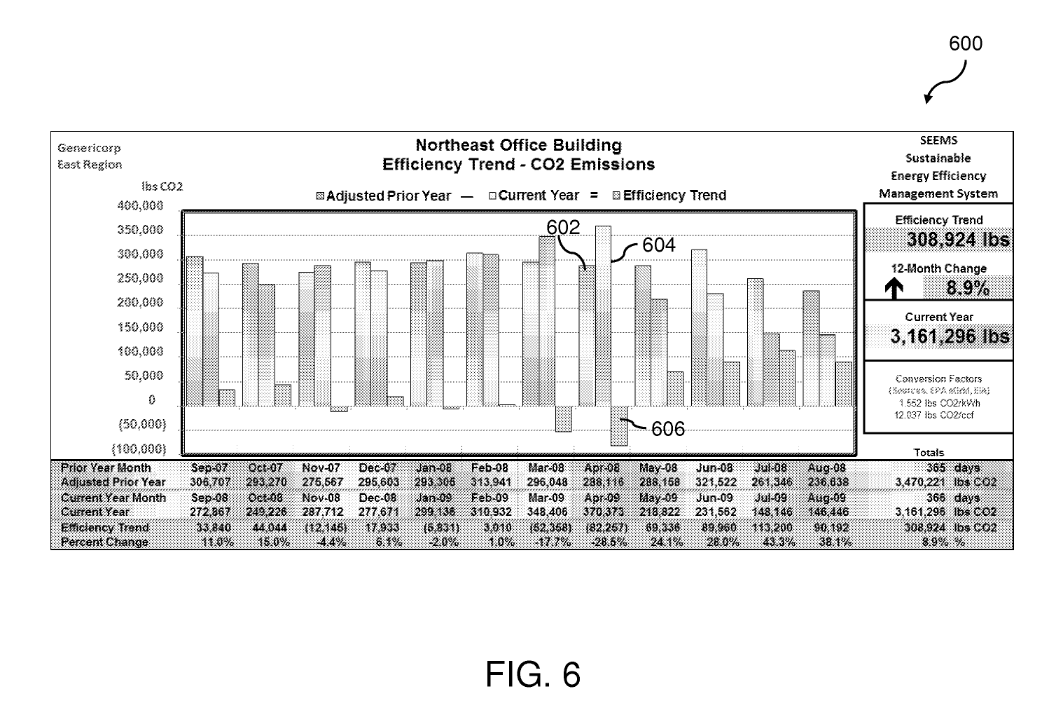

While FIG. 3 illustrates an energy efficiency trend report 300 for electricity consumption, FIG. 4 illustrates an energy efficiency trend report 400 for natural gas consumption. The content and layout of the energy efficiency trend report 400 is substantially similar to the energy efficiency trend report 300 just described, except that the energy use parameter relates to natural gas, rather than electricity. FIG. 5 illustrates an energy efficiency trend report 500 for the total energy use by a building (in this case, the combination of the electric and natural gas energy use). In FIG. 5, the energy use data is expressed in a common unit, MMBtu, which is especially useful when there are mixed sources of heating and cooling energy. FIG. 6 illustrates an energy efficiency trend report 600 that converts the electric and natural gas efficiency trends into their equivalent pounds of CO2 emission values. The energy efficiency trend report 600 is especially useful if a user is interested in validating any carbon reductions resulting from their energy savings efforts. It will be appreciated by those of skill in the art that the reports described here may be readily applied to other sources of energy for a building, such as coal, fuel, etcetera.

The hosted software platform 106 provides information and variety of reports 120 that answer important energy efficiency management questions to help bolster the sustainable energy efficiency business process 108, including, but not limited to: Are we using too much energy? Are we using more energy than we used to? Are we using more energy than our peers in similar buildings? How does our current energy use compare with our past use? How does our current energy use compare to our peers' energy use? How has our monthly energy efficiency changed over the past the past 12 months? Are our energy efficiency efforts working? How well are our energy efficiency efforts working since we started the program several years ago? Is our building energy use optimal, average, or excessive? When is our building's energy use excessive? How does the excessive use impact our budget on a daily, monthly, or annual basis? Where should we focus our energy efficiency efforts? Did our efforts over a specific time period in the past work to reduce energy use? Are our efforts still working months or years after the improvement? Are our utility bill changes due to energy use changes, utility rate changes, or both?

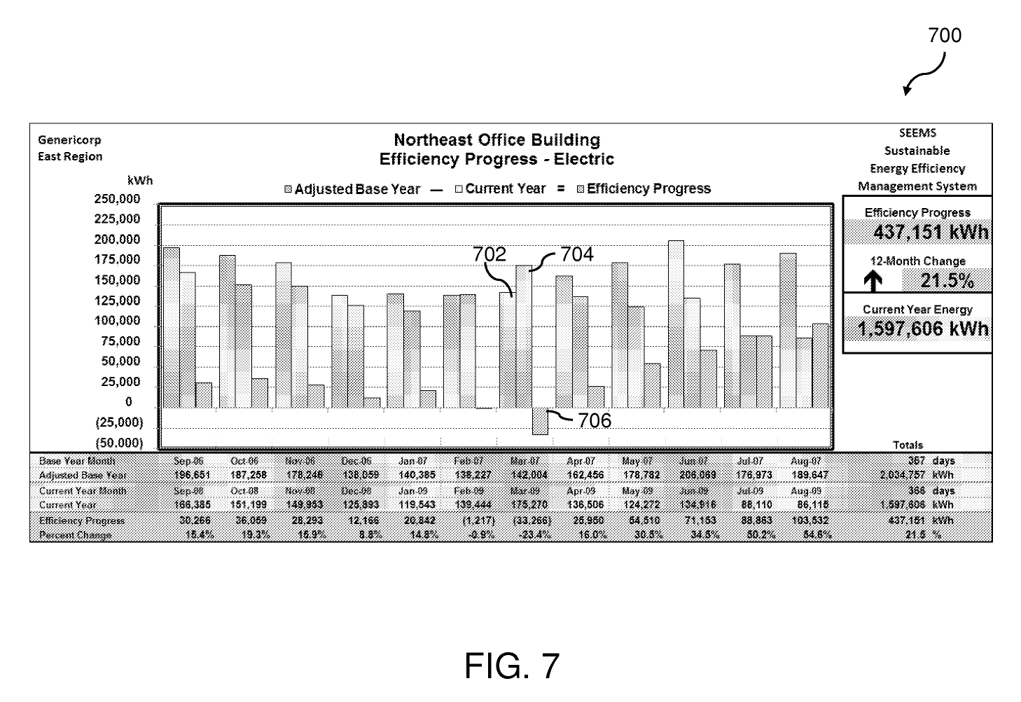

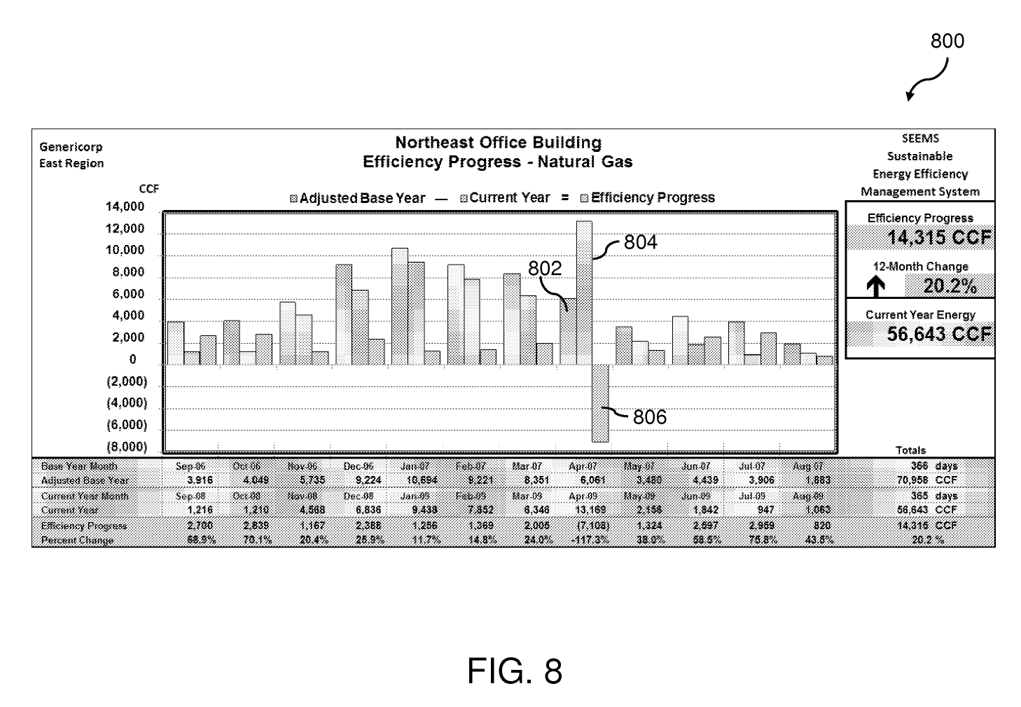

To help answer these questions, several more informative reports 120 have been developed that are generated by the hosted sustainable energy efficiency software platform 106. In addition to the trend reports 300, 400, 500, 600 discussed above, which each compare the most recent twelve months (i.e., the current year) with the twelve months immediately prior to the current year (i.e., the prior year is used as the base year), a “progress” report uses the same method to compare energy use data, but uses a base year that may be farther in the past. One possible base year for a progress report may be the twelve months before implementing the SEEMS 100. Another possible base year for a progress report may be the twelve months before an energy savings project was implemented. FIG. 7 shows on illustrative embodiment of an energy efficiency progress report 700 for electricity consumption. The energy efficiency progress report 700 illustrates the overall progress that has been achieved in the two years since the base year ending in August 2007. FIGS. 8-10 show illustrative embodiments of an energy efficiency progress report 800 for natural gas consumption, of an energy efficiency progress report 900 for total energy use, and of an energy efficiency progress report 1000 for equivalent CO2 emissions, respectively. Once again, the content and layout the energy efficiency progress reports 700, 800, 900, 1000 are substantially similar to the energy efficiency trend reports 300, 400, 500, 600 described above, except that a base year other than the twelve months immediately preceding the current year is used as a comparison point (and to generate the first bars 702, 802, 902, 1002).

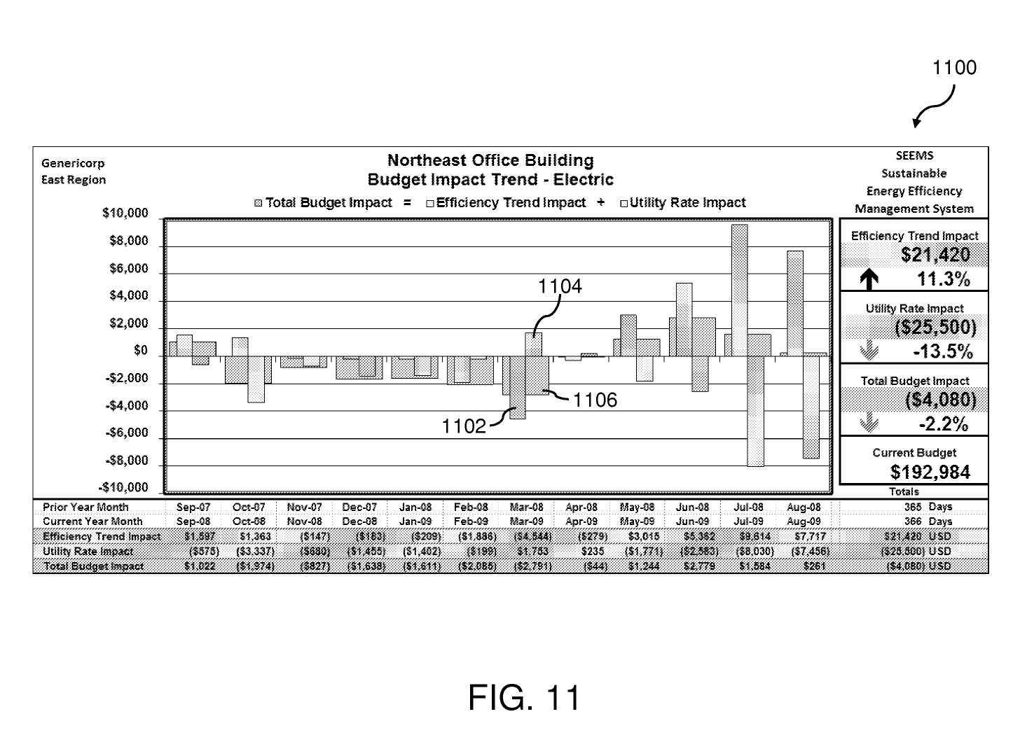

FIG. 11 shows one illustrative embodiment of a budget impact trend report 1100 for electricity consumption that provides a breakdown of electric energy budget changes into its two primary components: those cost changes associated with energy efficiency changes and those cost changes associated with utility rate changes. Since it is a “trend” report, rather than a “progress” report, the budget impact trend report 1100 is comparing the most recent twelve months to the immediately preceding twelve months. In this illustrative embodiment, the overall impact of the efficiency trend and rate changes is the total budget impact:
Efficiency Trend Impact: A measurement of the impact of the change in energy use, correcting for weather, billing period, etc., multiplied by the current rate.

=(Adjusted Prior Use−Current Use)×Current Rate
Utility Rate Impact: A measurement of the impact of the change in the energy rate from the base year to the current year, multiplied by the adjusted prior use.

=(Prior Rate−Current Rate)×Adjusted Prior Use
Total Budget Impact: A measurement of the total impact from energy use reduction efforts and from factors affecting the rate.

$$= Energy Trend Impact + Utility Rate Impact \\ = ( Adjusted Prior Use - Current Use ) \times Current Rate + ( Prior Rate - Current Rate ) \times Adjusted Prior Use$$

These formulas can be reduced to:
Total Budget Impact:

$$= Adjusted Prior Use \times Prior Rate - Current Use \times Current Rate \\ = Adjusted Prior Cost - Current Cost$$

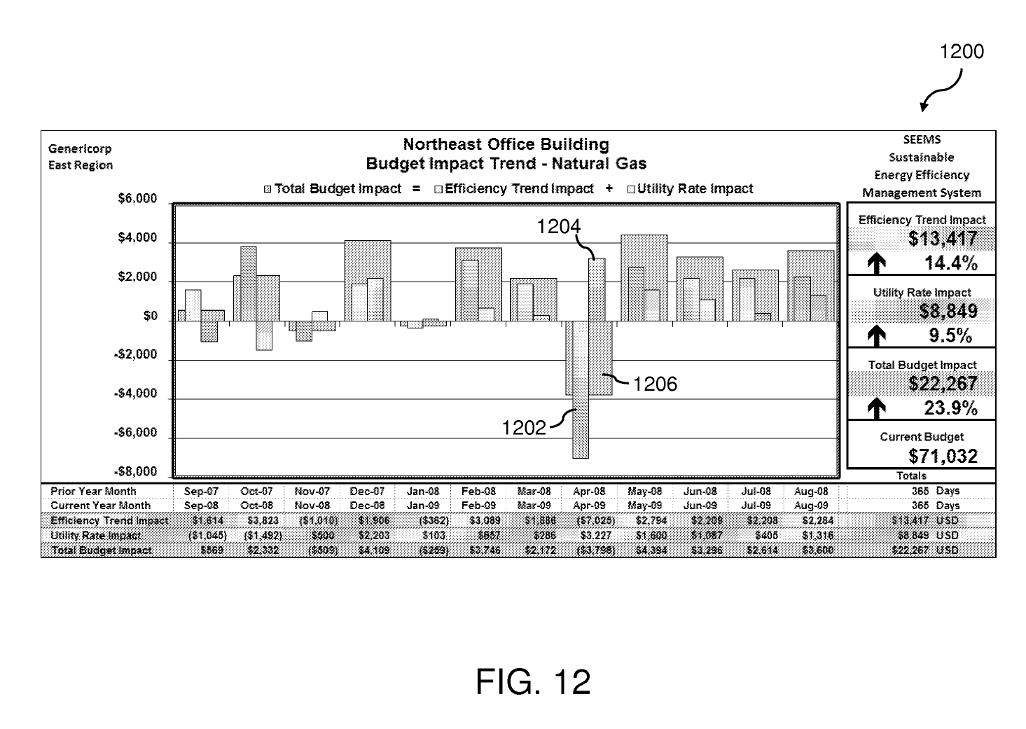

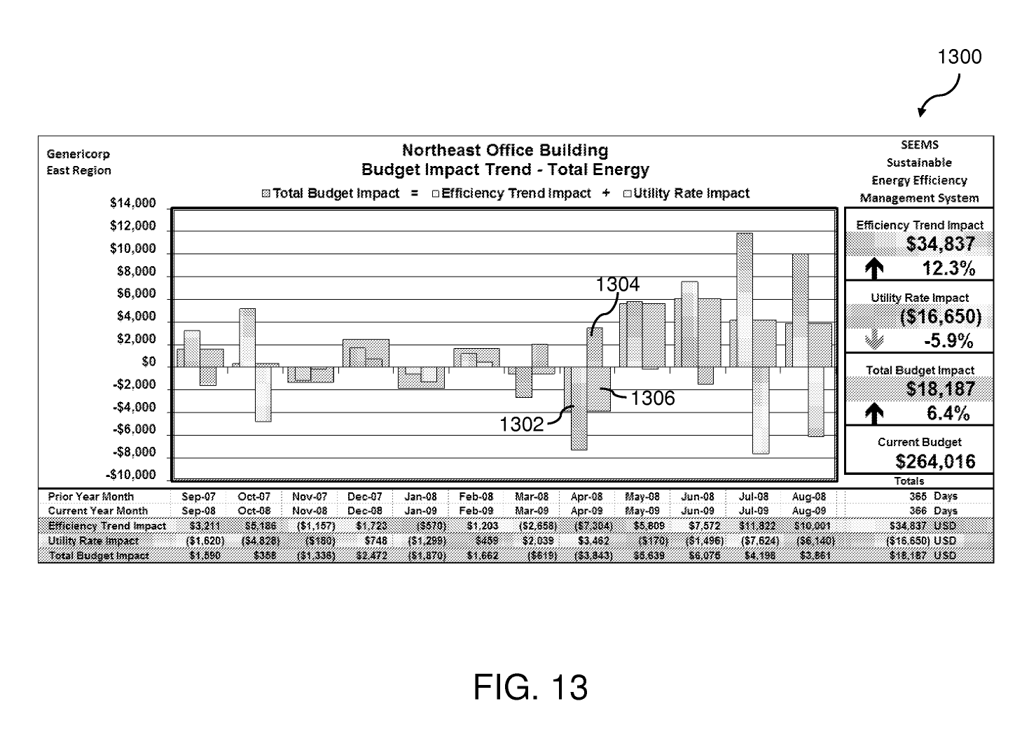

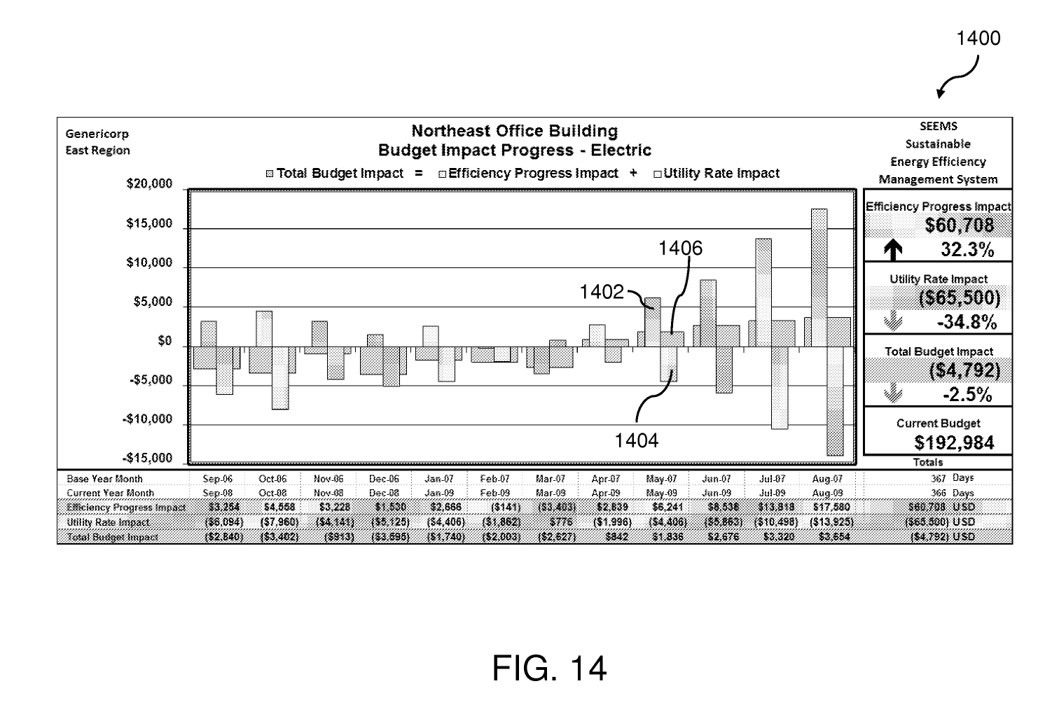

Budget impact reports may be embodied as either “trend” or “progress” reports, can be used to evaluate any type of energy use parameter (e.g., electric consumption or natural gas consumption), and can be combined into a “total energy” budget impact trend/progress report. As shown in FIG. 11, the graphic used in the budget impact trend report 1100 shows the Efficiency Impact as a first bar 1102 and the Rate Impact as a second bar 1104 that are both superimposed on a third bar 1106, which is wider than the combination of the two first and second bars 1102, 1004 and which represents their algebraic total, i.e., the Total Budget Impact. This arrangement is especially useful because the impact of all three quantities can be readily observed individually (unlike other charting options, such as a stacked bar chart, which hides the impact of the bars that are stacked on top of the bottom one since the baseline of the upper bars is constantly changing from month to month as the length of the bottom bars increase and decrease). FIGS. 12 and 13 illustrate embodiments of a budget impact trend report 1200 for natural gas and a budget impact trend report 1300 for total energy, respectively. FIGS. 14-16 illustrate embodiments of a budget impact progress report 1400 for electricity, a budget impact progress report 1500 for natural gas, and a budget impact progress report 1600 for total energy, respectively. As with the energy efficiency reports described above, the difference between the “trend” and “progress” reports is the difference in the base year used for comparison to the current year's energy use data.

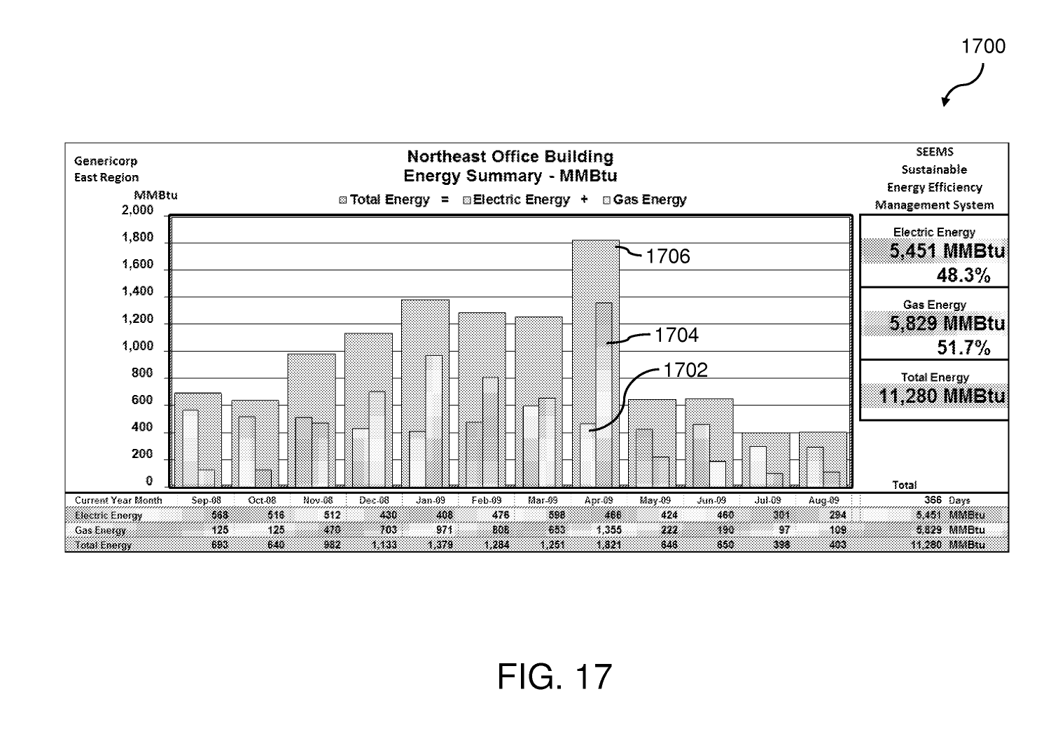

For those users that desire to know their overall energy use or want to compare buildings to each other on a total energy use basis, the total energy summary report 1700 shown in FIG. 17 is one illustrative embodiment of a “summary” report combining all energy sources into one report. The total energy summary report 1700 shows electric and natural gas energy use data converted into millions of Btu's (MMBtu), a common energy unit used for comparing building energy. It will be appreciated that other common energy units might also be used, such as the equivalent kilowatt-hour (ekWh) or the megajoule (MJ). Similar to the budget impact reports described above, the graphic used in the total energy summary report 1700 shows the individual energy sources as first and second bars 1702, 1704 superimposed on a wider third bar 1706 that represents their total. The total energy summary report 1700 is especially useful in that the use trend of all three quantities can be readily observed individually.

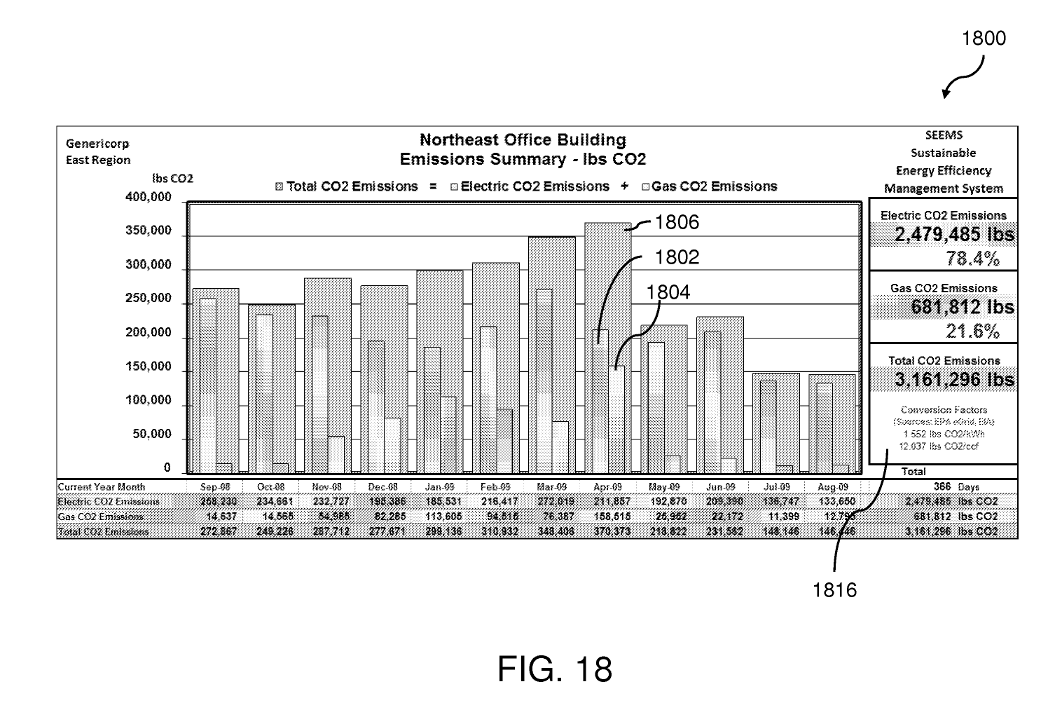

For those customers who desire to track carbon emissions, FIG. 18 is one illustrative example of a CO2 emissions report 1800 that uses first and second bars 1802, 1804 superimposed on a wider third bar 1806, similar to those just described for the total energy summary report 1700. The factors used in calculating the carbon emissions associated with the different energy types are shown in the summary area 1816 on the right side of the CO2 emissions report 1800. These factors represent the latest values available at the time of the CO2 emissions report 1800 and are based on the electric grid to which the building is connected and the current heat value of natural gas. The CO2 emissions report 1800 report uses units of pounds of CO2, though other embodiments may use other units to quantify the CO2 emissions and/or other emissions types, such as Nitrous Oxides (NOx).

The hosted software platform 106 creates useful “building types” that are groups of buildings that have similar construction, equipment, and operations. The hosted software platform 106 maintains these groupings as large as practicable to enable benchmarking against a significant population of buildings, yet not so large as to contain buildings of dissimilar natures. Fully deployed, the hosted software platform 106 will have hundreds of building types across many regions and climate zones for enhanced comparison capabilities.

The hosted software platform 106 implements a rating system that includes several dimensions of energy efficiency performance. In the illustrative embodiment, the overall rating against peer buildings is a weighted combination of the following factors, each of which is a rating unto itself: (a) total energy intensity (Btu/sf/year), (b) overall energy efficiency improvement since joining the hosted software platform 106 (%), (c) latest quarter's energy efficiency improvement (%), and (d) percentage of months having sustained an improvement of at least 10% over the building's base year energy use (only months that used at least 5% of the annual energy use are used in the computation).

The hosted software platform 106 also produces graphics, alerts, reports, and displays that may inform and engage the following user groups of the SEEMS 100 in the pursuit of energy efficiency, by way of example: (a) executives in the building's organization, (b) building management, (c) building operations and staff, (d) building support and service personnel, (e) building occupants and visitors, and (f) system analysts. The hosted software platform 106 may generate automatic, electronic alerts based on detection of significant deviations in demand and/or duration from expected energy use ranges, including deviations normalized for weather. During setup, the hosted software platform 106 may determine the above roles via usernames and passwords. These roles may be managed on an ongoing basis by the customer via their administrative webpage. Building occupants and visitors may be informed via digital signage and other broadcast methods, such as lobby kiosks, VOIP phone displays or text messages, by way of example. The hosted software platform 106 engages users of the SEEMS 100 in the most effective manner possible, so as to keep each user engaged in the energy efficiency management process.

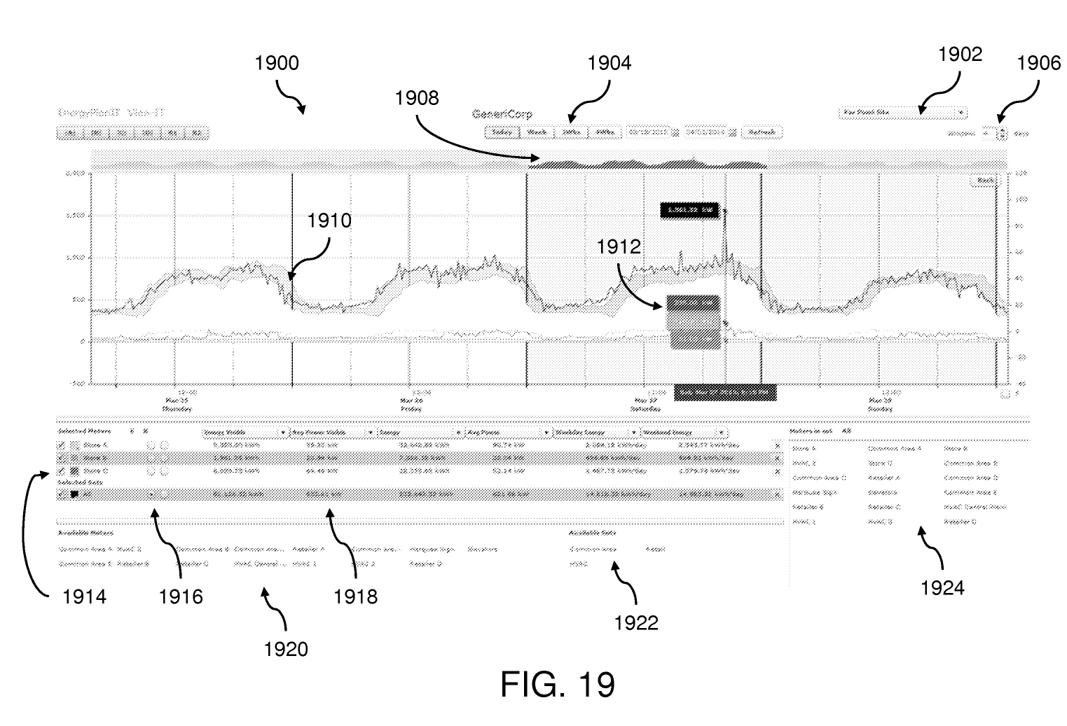

A single screen application 1900 is included in the hosted software platform 106, allowing a user to organize and monitor an entire enterprise. FIG. 19 shows one illustrative embodiment of such a single screen application 1900. The single screen application 1900 may be accessed over the Internet or a LAN using a standard web browser. In the illustrative embodiment, the hosted software platform 106 may provide one or more of following information display features as part of the single screen application 1900: a continuous display of energy readings; instant quantification within any selected time frame; energy usage viewable with or without current outside air temperature readings; customized, pre-set time frame tabs and active, rolling cursor readings; single-click, expandable views for greater detail with single-click return; drill down alert message review buttons; the latest building performance reports by month, quarter, and year; customized performance data sets delivered to digital signage; and variable base year analysis and unique trend reporting.

As illustrated in FIG. 19, the single screen application 1900 may include a pull-down list 1902 to select a building or group of buildings to be analyzed. One or more buttons 1904 may be used to select a pre-determined time period and/or a pull-down calendar for selecting start and stop dates. The single screen application 1900 allows selection of a visible window 1906 that is a subset of the total date range selected. The single screen application 1900 includes a miniature version 1908 of an energy use profile for the total date range selected, with a lighter section indicating the visible window that is plotted in the main chart area below it. One or more energy use profiles 1910 from the interval data are plotted and may be superimposed on an expected energy use envelope (in gray), developed from each time interval's recent history or other criteria. Alerts may be generated by comparing the actual load profile to the expected values using an algorithm designed to provide informative alerts and to avoid sporadic alerts or an excessive number of alerts. As the chart is scrolled over (e.g., via a computer mouse pointer), values 1912 for the selected meters may be shown with the day, date, and time of the interval shown below the chart. The single screen application 1900 allows for specific meters 1914 (and/or sets of meters 1914) to be selected and to be removed as desired. An envelope of an expected range of values, or the expected value itself, may able to be toggled on/off for each meter individually using the buttons 1916. Pull-down menus 1918 allow for the quantification of energy information within the entire date range selected. The single screen application 1900 includes lists 1920 of available meters for this building or group of buildings and lists 1922 of available sets of meters that have been combined to form informative groupings for display. The single screen application 1900 also includes a contextual information block 1924 that displays detailed information, results of alerts, and reported energy efficiency information as other items on the screen are scrolled over or selected. As shown in FIG. 19, the contextual information block 1924 is showing the meters in set “All.”

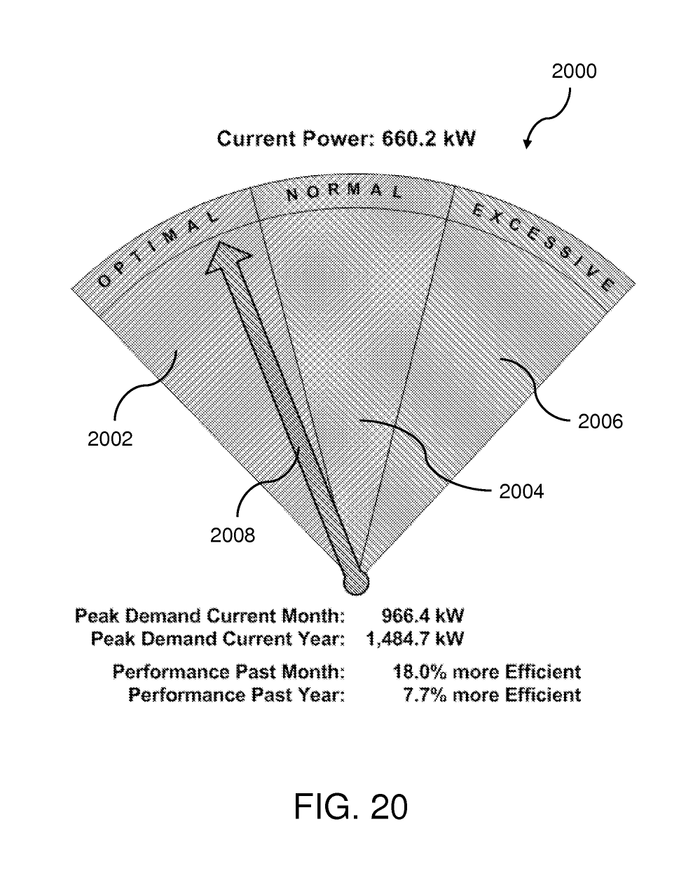

To effectively communicate energy efficiency monitoring results to as many people as possible, simple graphics, such as the “Optimal-Normal-Excessive” or “ONE” graphic 2000 shown in FIG. 20, may be used to convey energy efficiency status. In the illustrative embodiment of FIG. 20, “Optimal” energy efficiency means that energy use is below what is calculated to be the expected energy use range. “Normal” would indicate that energy use is near the expected energy use range, and “Excessive” would indicate that energy use is above the expected energy use range. In one embodiment, an expected energy use range can be determined by a weighted average of energy use in one or more similar time periods in the building's past. In another embodiment, an expected energy use range can be determined by a normalized, weighted average of energy use in one or more past time periods for one or more similar buildings. “Similar buildings” are buildings that share one or more similar building characteristics and which may grouped into a “building type.” To make for easy interpretation of the “ONE” graphic 2000, one embodiment uses the following color scheme: green for the Optimal sector 2002, blue for the Normal sector 2004, and red for the Excessive sector 2006. The arrow 2008 may have a contrasting color, such as yellow or white.

To be sustainable from a continuity of use standpoint, the SEEMS 100 should respond to changing conditions. As such, the software of the SEEMS 100 is split into the hosted software platform 106, installed on one or more hosted servers, and the local software platform 104, installed on the hardware platform 102. The ability to operate independently enables the hardware platform 102 to operate as a stand-alone installation that itself provides significant value. This value is increased when the local software platform 104 is kept up-to-date by the hosted software platform 106, available as a monthly service. The local software platform 104 periodically synchronizes with the hosted software platform 106 during its reporting in process. At that time, any new updates are sent back to the local software platform 104 from the hosted software platform 106. These updates might include the latest operating software updates, configuration information, building information updates, and comparative parameters so that the local software platform 104 can compare local energy use to that of one or more similar buildings.

While the previously described reports used automated linear regression to determine adjusted energy use data from historic time periods (i.e., a base year), it is also contemplated that the automated linear regression can be used on energy use data from the current year. This method can be used to determine what the energy efficiency results might be if the long-term average values for independent variables, such as production or outside air temperature, were applied to the current year energy use data. This method may be useful to compare results over large geographic regions, for example, which can have vastly different temperature profiles, resulting in some buildings experiencing harsher weather, others milder. These normalized energy efficiency trend and progress results can be affected by the severity of weather. For instance, improvements in air conditioning operations may provide much higher energy efficiency values during hotter than normal summers. On the other hand, if the summer weather is mild, the opportunity to save on cooling energy is reduced, resulting in lower energy efficiency improvements.

Returning again to FIG. 1, the sustainable energy efficiency business process 108 lies between the building executives and management team 122 and three primary groups: building managers 124, the building maintenance team 126, and building occupants and visitors 128. All four groups impact the energy use of a building. An information gap exists between these four groups that can only be bridged by the effective communication of actionable insight into normalized building performance. The gap exists because of a lack of objective metrics to show status and progress, thus there is no accountability mechanism at work. By providing a steady stream of building performance information, building executives and management teams 122 using the SEEMS 100 can establish quantifiable goals and then measure progress using normalized results from a standardized methodology on a regular basis. This creates a true budget and management process over building energy costs, a previously uncontrolled operating expense. Given better energy efficiency status and progress information, building executives and management teams 122 can properly allocate limited resources to those buildings and programs that show poor or marginal results and reward those achieving positive results. In turn, building managers 124 will have a set of building performance monitoring and tracking tools to keep the building maintenance team 126 accountable for improving energy efficiency. In turn, the building maintenance team 126 will have the same performance tracking information as their supervisors with which to hold outside service technicians and vendors accountable for the effectiveness of their work. Moreover, the detailed interval data that is recorded during anomalous energy use alerts provides a diagnostic tool that dramatically improves the productivity and effectiveness of all technicians who adjust and maintain building systems. As building efficiency improvements are documented over time, these energy efficiency improvement activities are supported and made sustainable by using the SEEMS 100. Finally, building occupants and visitors 128 are not currently accountable for the energy they use during their time in the building. The effective communication of organizational goals, recent trends, and current status is often all that is required to initiate positive and sustainable behavioral changes. Digital displays, kiosks, internal messaging, and posters are possible ways to present this information to building occupants and visitors 128 who will be made aware they are presently in a performance-validated “green” building, helping to further inspire energy efficient practices by all occupants and visitors.

In one illustrative embodiment, the sustainable energy efficiency business process 108 may have the following characteristics: the business process 108 has the top-level support of an organization; the business process 108 encourages actually saving energy; the business process 108 has a support staff that is able to respond to energy issues as they are detected by the SEEMS 100; the business process 108 engages users of the SEEMS 100 in the most effective manner practicable so as to keep the user engaged in the energy efficiency management process; the business process 108 engages the breadth of personnel who are responsible for energy use in the building, so that accountability is established and maintained for how energy is used by those who interact with factors that influence the building's energy use; the business process 108 establishes a clear program to enhance a positive and quantifiable corporate citizen status for the building occupants, operations staff, managers, visitors and owners; the business process 108 captures and reallocates resources during the optimization process, providing a net positive bottom-line impact for the organization that occupies and manages the building; the business process 108 sustains a true improvement process by providing actionable information to the appropriate person(s) at the appropriate time(s) in the appropriate format(s); the business process 108 bridges the communications chasm that has existed between executives in charge of building operations and the building operators and occupants, leading to greater accountability, enabling the executives to ask direct questions about the energy efficiency status of any building based on the ongoing performance tracking and peer-to-peer comparisons; the business process 108 may be integrated into other business processes, such as budgeting, but remains independent of these other processes to preserve maximum effectiveness.

The SEEMS 100 allows for multiple base years to be used in generated reports, so that different constituency groups can monitor energy efficiency progress from different starting points. The SEEMS 100 also allows for four different report groupings that can be established by the customer. Some of these groupings may benefit building managers; others might benefit the financial executives, while others may be useful for building technicians. Each report grouping has sub-groups and each building belongs to one of the sub-groups in each of the report groupings. This results in each building belonging to up to four sub-groups. While customers may group their buildings in ways that suit them, each building is also grouped in accordance with “building types” used by the SEEMS 100. These groupings enable the SEEMS 100 to perform meaningful comparisons and to perform roll-up reporting by different standardized groupings. This provides the ability for administrators and analysts to track performance of the SEEMS 100 across various metrics and helps improve system performance.

While the concepts of the present disclosure have been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected.

1. A graphical energy efficiency report comprising:
a first graphical element illustrating an adjusted energy use parameter for a building during a historic time period;
a second graphical element illustrating an energy use parameter for the building during a current time period, the historical time period corresponding to the current time period; and
a third graphical element illustrating a difference between the adjusted energy use parameter for the building during the historic time period and the energy use parameter for the building during the current time period.

2. The graphical energy efficiency report of claim 1, wherein the adjusted energy use parameter for the building during the historic time period is the result of an automated regression analysis that adjusts an actual energy use parameter for the building during the historic time period for changed conditions between the historic time period and the current time period.

3-4. (canceled)

5. The graphical energy efficiency report of claim 1, wherein the current time period is one month of a current year and the historic time period is one corresponding month of a base year.

6. The graphical energy efficiency report of claim 5, wherein the current year comprises the most recent twelve months and the base year comprises the twelve months immediately preceding the most recent twelve months.

7. The graphical energy efficiency report of claim 5, wherein the current year comprises the most recent twelve months and the base year comprises twelve months other than the twelve months immediately preceding the most recent twelve months.

8. The graphical energy efficiency report of claim 5, wherein the first, second, and third graphical elements are displayed for each month of the current year.

9. The graphical energy efficiency report of claim 8, wherein the current year comprises the most recent twelve months and the base year comprises the twelve months immediately preceding the most recent twelve months.

10. The graphical energy efficiency report of claim 8, wherein the current year comprises the most recent twelve months and the base year comprises twelve months other than the twelve months immediately preceding the most recent twelve months.

11-13. (canceled)

14. The graphical energy efficiency report of claim 1, wherein the first graphical element comprises a first bar of a bar graph, the second graphical element comprises a second bar of the bar graph, and the third graphical element comprises a third bar of the bar graph.

15. The graphical energy efficiency report of claim 14, wherein each of the first, second, and third bars is located above an axis of the bar graph when representing a positive value and below the axis of the bar graph when representing a negative value.

16. The graphical energy efficiency report of claim 1, wherein the first graphical element comprises a first color, the second graphical element comprises a second color, and the third graphical element comprises a third color.

17-19. (canceled)

20. The graphical energy efficiency report of claim 1, wherein the energy use parameter and the adjusted energy use parameter both comprise an electricity consumption of the building.

21. The graphical energy efficiency report of claim 1, wherein the energy use parameter and the adjusted energy use parameter both comprise a natural gas consumption of the building.

22. The graphical energy efficiency report of claim 1, wherein the energy use parameter and the adjusted energy use parameter both comprise a total energy consumption of the building.

23. The graphical energy efficiency report of claim 1, wherein the energy use parameter and the adjusted energy use parameter both comprise an equivalent CO2 emissions value of the building.

24. One or more computer-readable media comprising a plurality of instructions that, when executed by a processor, result in the processor generating a graphical energy efficiency report according to claim 1.

25. A graphical budget impact report comprising:
a first graphical element illustrating an energy efficiency budget impact for a building during a current time period as compared to a historical time period corresponding to the current time period;
a second graphical element illustrating a utility rate budget impact for the building during the current time period as compared to the historical time period; and
a third graphical element illustrating a sum of the energy efficiency budget impact and the utility rate budget impact for the building during the current time period as compared to the historical time period.

26-49. (canceled)

50. One or more computer-readable media comprising a plurality of instructions that, when executed by a processor, result in the processor generating a graphical budget impact report according to claim 25.

51-63. (canceled)

64. A method for sustainable energy efficiency management, the method comprising:
generating one or more energy efficiency analyses relating to a building by comparing energy use data for the building during a current time period to adjusted energy use data for the building during a historical time period corresponding to the current time period; and
communicating the one or more energy efficiency analyses to at least one of a building executive, a building manager, a building maintenance technician, and a building occupant or visitor.

65-67. (canceled)

68. The method of claim 64, wherein the adjusted energy use data for the building during the historic time period is the result of an automated regression analysis that adjusts actual energy use data for the building during the historic time period for changed conditions between the historic time period and the current time period.

69-99. (canceled)
